(19) United States
(12) Patent Application Publication
(10) Pub. No.: US 2026/0052466 A1
(43) Pub. Date: Feb. 19, 2026

(54) METHODS, ARCHITECTURES, APPARATUSES AND SYSTEMS FOR ENABLING OPERATION WITH MINIMAL TRANSMISSION OF COMMON REFERENCE SIGNALS

(71) Applicant: InterDigital Patent Holdings, Inc., Wilmington, DE (US)

(72) Inventors: Jaya Rao, Montreal (CA); Faris Alfarhan, Montreal (CA); Paul Marinier, Brossard (CA); Umer Salim, Vallauris (FR); Ananth Kini, Conshohocken, PA (US)

(21) Appl. No.: 18/808,372

(22) Filed: Aug. 19, 2024

(51) Int. Cl. H04W 52/02; H04B 7/06; H04B 17/318; H04L 5/00; H04W 24/10

(52) U.S. Cl. CPC H04W 52/0206; H04B 7/06966; H04B 17/328; H04L 5/0051; H04W 24/10

(57) ABSTRACT

Procedures, methods, architectures, apparatuses, systems, devices, and computer program products relating or directed to a WTRU performing or determining to perform a mobility event, such as cell switch, handover or reselection, to a network energy savings (NES) cell based on information received from a serving cell on the beams of a first reference signal (RS) configuration and a second RS configuration associated with the NES cell.

### FIELD

Example embodiments described in the present disclosure are generally directed to the fields of communications, software and encoding, including, for example, to methods, architectures, apparatuses, systems related to enabling operation of a communications system with minimal transmission of reference signals (RS).

### BACKGROUND

Network energy savings relates to enhancements that enable the network to minimize its power consumption from transmission and/or reception. Such minimization of power consumption can be beneficial for reducing operational costs and for environmental sustainability.

### SUMMARY

Some embodiments may be directed to a wireless transmit/receive unit (WTRU), which may include circuitry such as a processor, memory, transmitter and/or receiver. The circuitry may be configured to receive configuration information including (1) first reference signal configuration information associated with a network energy savings cell and (2) second reference signal configuration information associated with the network energy savings cell. The first reference signal configuration information indicates any of a periodicity associated with a first reference signal, one or more indexes associated with the first reference signal, and number of beams in a burst associated with the first reference signal. The second reference signal configuration information indicates an association between beams associated with the first reference signal and beams associated with a second reference signal and any of a periodicity associated with the second reference signal, one or more indexes associated with the second reference signal, and number of beams in a burst associated with the second reference signal. The circuitry may be configured to receive first information indicating to perform measurements on the beams associated with the first reference signal that are received from the network energy savings cell, where the first information includes any of the one or more indexes associated with the first reference signal and an identifier associated with the network energy savings cell. The circuitry may be configured to send a measurement report indicating any of measured signal characteristics of the beams associated with the first reference signal and information associated with a selected beam from the beams associated with the first reference signal. The circuitry may be configured to receive second information indicating to perform measurements on the beams associated with the second reference signal that are received from the network energy savings cell, where the second information includes any of the one or more indexes associated with the second reference signal, one or more indexes associated with beams associated with the second reference signal, and an identifier associated with the network energy savings cell. The circuitry may be configured to determine, based on the second reference signal configuration information and on the one or more indexes associated with the beams associated with the second reference signal, a spatial relation for measuring the beams associated with the second reference signal. The circuitry may be configured to send a measurement report indicating any of measured signal characteristics of the beams associated with the second reference signal and information associated with a selected beam from the beams associated with the second reference signal. The circuitry may be configured to transmit, based on the spatial relation, third information in a beam associated with the selected beam from the beams associated with the second reference signal.

Some embodiments may be directed to a method, which may be implemented by a WTRU or other network node. The method may include receiving configuration information including (1) first reference signal configuration information associated with a network energy savings cell and (2) second reference signal configuration information associated with the network energy savings cell. The first reference signal configuration information indicates any of a periodicity associated with a first reference signal, one or more indexes associated with the first reference signal, and number of beams in a burst associated with the first reference signal. The second reference signal configuration information indicates an association between beams associated with the first reference signal and beams associated with a second reference signal and any of a periodicity associated with the second reference signal, one or more indexes associated with the second reference signal, and number of beams in a burst associated with the second reference signal. The method may include receiving first information indicating to perform measurements on the beams associated with the first reference signal that are received from the network energy savings cell, where the first information includes any of the one or more indexes associated with the first reference signal and an identifier associated with the network energy savings cell. The method may include sending a measurement report indicating any of measured signal characteristics of the beams associated with the first reference signal and information associated with a selected beam from the beams associated with the first reference signal. The method may include receiving second information indicating to perform measurements on the beams associated with the second reference signal that are received from the network energy savings cell, where the second information includes any of the one or more indexes associated with the second reference signal, one or more indexes associated with beams associated with the second reference signal, and an identifier associated with the network energy savings cell. The method may include determining, based on the second reference signal configuration information and on the one or more indexes associated with the beams associated with the second reference signal, a spatial relation for measuring the beams associated with the second reference signal. The method may include sending a measurement report indicating any of measured signal characteristics of the beams associated with the second reference signal and information associated with a selected beam from the beams associated with the second reference signal. The method may include transmitting, based on the spatial relation, third information in a beam associated with the selected beam from the beams associated with the second reference signal.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2A illustrates an example of a system implementing some embodiments;

FIG. 2B illustrates an example of a system implementing some embodiments;

FIG. 2C illustrates an example of a system implementing some embodiments; and

FIG. 3 illustrates an example flow diagram of a method, according to some embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

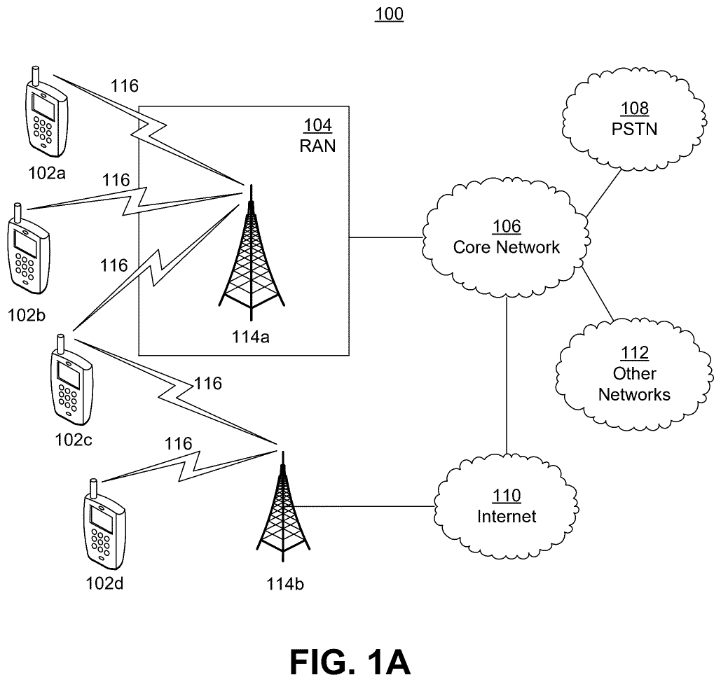

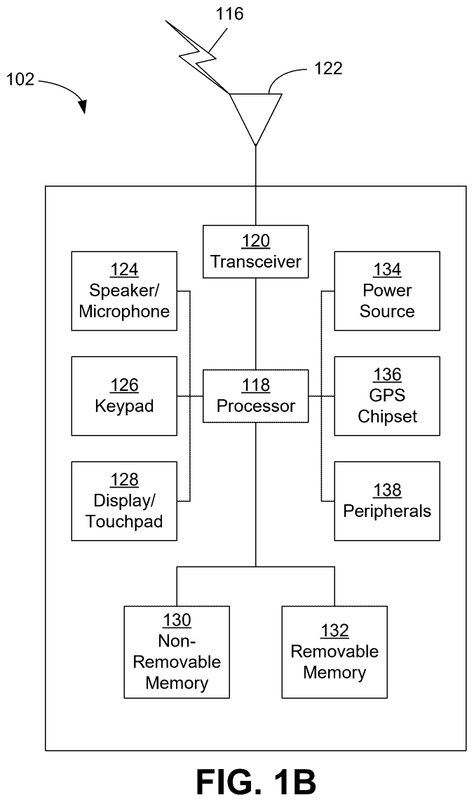

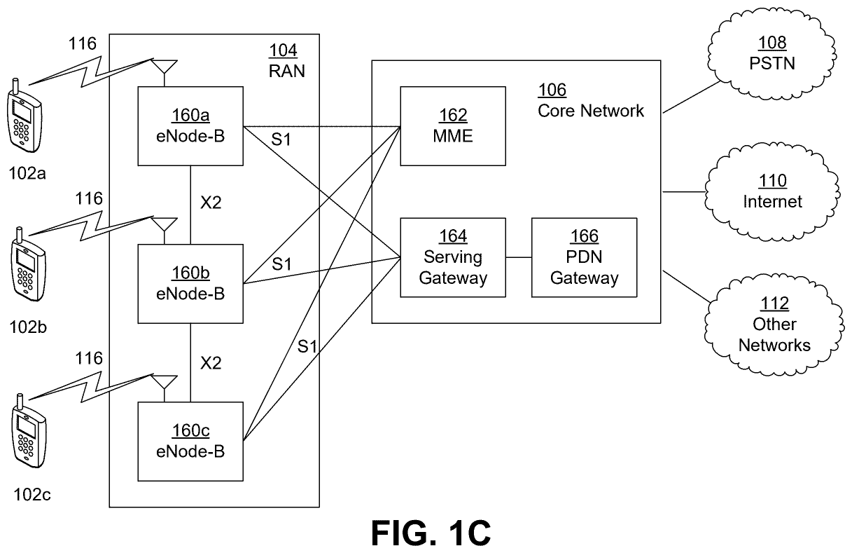

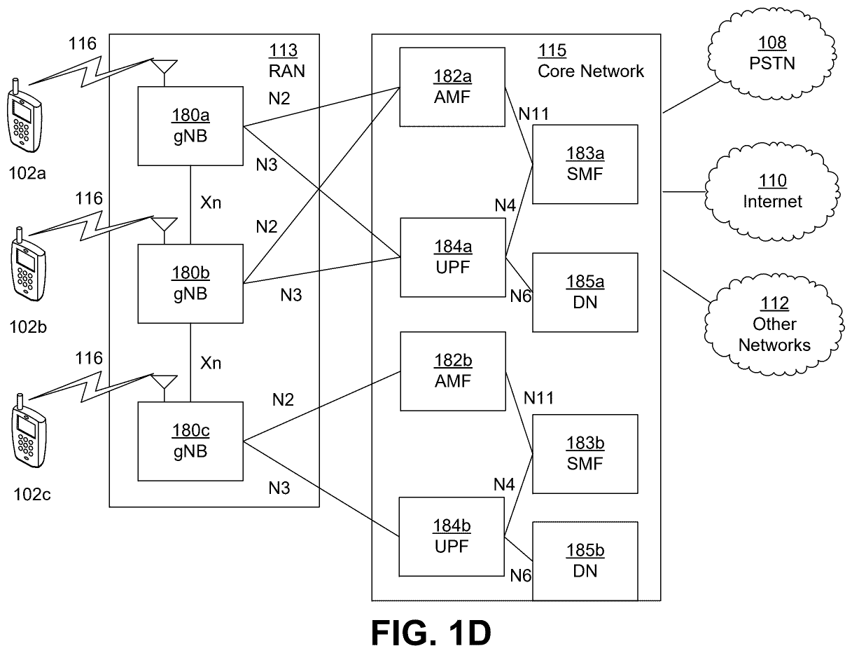

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d, or any other WTRU mentioned or described herein, may be interchangeably referred to as a UE or vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Embodiments disclosed herein are representative and do not limit the applicability of the apparatus, procedures, functions and/or methods to any particular wireless technology, any particular communication technology and/or other technologies. The term network in this disclosure may generally refer to one or more base stations or gNBs or other network entity which in turn may be associated with one or more Transmission/Reception Points (TRPs), or to any other node in the radio access network.

It is noted that, throughout example embodiments described herein, the terms “base station”, “serving base station”, “RAN,” “RAN node,” “Access Network,” “NG-RAN,” “gNodeB,” and/or “gNB” may be used interchangeably to designate any network element such as, e.g., a network element acting as a serving base station. It should be understood that embodiments described herein are not limited to gNBs and are applicable to any other types of base stations.

The current standards enable the network (NW) to minimize its energy consumption due to transmissions and receptions. For example, such network energy savings (NES) capabilities may include performing adaptations in multiple domains including in spatial domain (e.g., power off subsets of antenna ports, elements or panels), time domain (e.g. applying cell DTX/DRX or applying long periodicity for SSB transmissions), frequency domain (e.g., disabling certain carriers or BWPs) or power domain (e.g., applying lower power offset values).

While the NES enhancements supported in 3GPP Release 18 were specified with the assumption that the NW is lightly or moderately loaded in terms of achievable throughput by the UEs in cells, future releases or generations are expected to support more advanced capabilities and features for NES even in high load scenarios. In high load scenarios, the NW is assumed to be active most of the time, where the transmissions and receptions may be done when the load level is higher, for example, such as where it is at least 75%. Both the DL and UL traffic is expected to have high degree of dynamicity. For improving NES gains in high load, the NW nodes are expected to quickly transition to an NES mode after using high load capabilities (e.g. high number of antenna elements/ports, multiple transmission layers and carriers). In essence, for enabling greater energy savings at NW, it is desirable that the transmissions of always-on common signals/channels (e.g. SSBs) should be minimized. It is also desirable to support any of the WTRU CONNECTED and IDLE mode operations in cells with minimal reference signals.

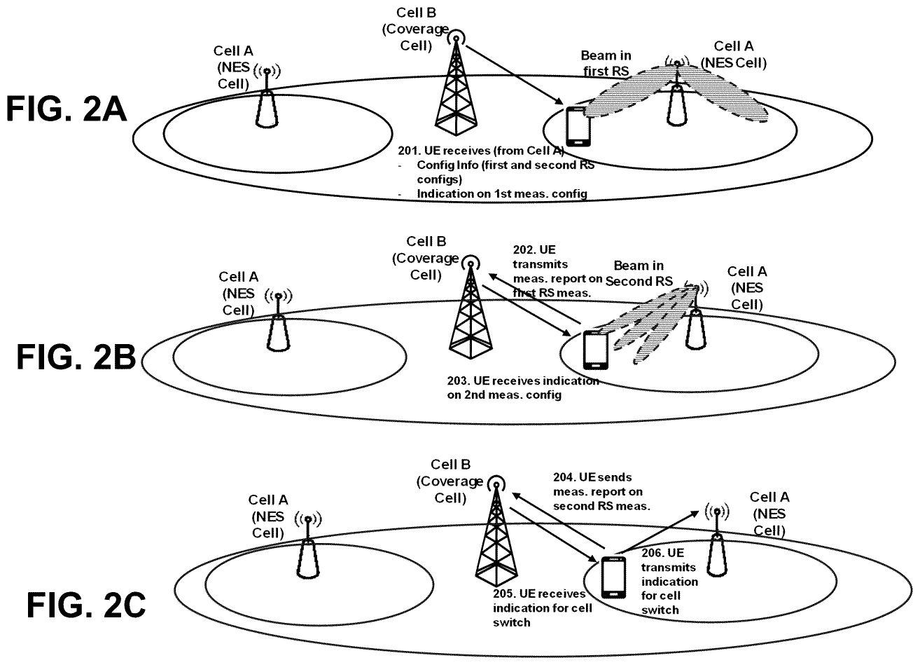

As an example, some embodiments may apply to a NW deployment, such as a multi-cell deployment that includes one or more NES cells that are overlaid on a coverage cell. As will be discussed in more detail below, FIGS. 2A, 2B and 2C illustrate examples of a system, according to some embodiments. For example, in some embodiments, a communications system may include one or more NES cells (e.g., cell A). The NES cell(s) may not transmit SSBs (e.g., always-on SSBs) and reference signals (RS), but may transmit NES-RS (e.g., may only transmit NES-RS), such as synchronization or sync signals, dynamic SSBs, etc. Such NES-RS may be transmitted irregularly with long periodicity and/or temporarily, e.g., during cell wake-up. Initial access for IDLE mode UEs might not be supported, e.g., a cell's resources may be optimized for energy savings and CONNECTED mode UEs.

In some embodiments, the communications system may include one or more cells (e.g., cell B) that may transmit SSBs (e.g., always-on SSBs) and can support IDLE and CONN mode UEs. For example, these cells may be or may be referred to as coverage and/or serving cells. According to certain embodiments, these cells may provide configuration information to a WTRU on the NES cell's NES-RS (e.g., cell A's NES-RS), e.g., for supporting offloading, cell switch, handover, reselection, and/or the like.

In some embodiments, a WTRU may be in CONN/IDLE mode with a coverage and/or serving cell (e.g., cell B). According to some examples, the WTRU may be offloaded to an NES cell, e.g., due to congestion at coverage cell or coverage cell may be transitioning to NES mode. Since cell B is not aware of the best NES for WTRU offloading, the WTRU may be configured to perform measurements of sync signals received from candidate NES cells. In some embodiments, the WTRU may request cell B for dynamic SSB transmission from a NES cell for performing subsequent measurements and cell-switch/cell reselection to cell A.

According to some embodiments, a WTRU may be expected to or configured to perform time/frequency sync and establish connectivity with one or more NES cell(s) (e.g., from which always-on SSBs are not transmitted), and/or to perform radio link monitoring and/or maintenance with one or more NES cell(s).

Some problems addressed by certain example embodiments discussed herein may consider or relate to at least the following types of NES-RS (e.g., applicable in a NES cell): sync signals (e.g. PSS/SSS only with long periodicity), and dynamic SSBs (e.g. dynamically triggered SSBs/RS that may be transmitted only within a limited time window, limited set of beams/directions, frequency band). Further, some example embodiments may relate to solutions for how to receive dynamic SSB resources associated with a NES cell and/or how to perform mobility, such as cell-switch, handover and/or reselection, to an NES cell that does not transmit always-on SSBs and/or transmits only NES-RS.

In NR, common signals, such as always-on SSBs, are transmitted by cell(s) to support multiple functionalities (e.g. T/F sync, initial access, RRM, RLM, BM/BFD). SSB configuration(s) (e.g. ssb-PositionsInBurst, ssb-PeriodicityServingCell, ss-PBCH-BlockPower) are provided in SIB1, which the WTRU receives in PDSCH indicated by Type0-PDCCH (SI-RNTI) in CORESET-0/SS-0. 3GPP Release19 NES is introducing on-demand SSBs (OD-SSBs) for WTRUs in CONN mode. The Release 19 scenarios where OD-SSBs may be applicable include CA operation during the activation of SCell.

The transmission of always-on SSBs to serve multiple functionalizes (e.g. T/F sync, initial access, RLM) results in high energy consumption at the NW. In 6G scenarios, it may be desirable to support at least the existing functionalities with lower NW resources for energy savings. Thus, some example embodiments can address at least the issues of how WTRU mobility, such as cell-switch, handover and/or reselection, can be supported to a cell that is operating in NES mode with no or minimal SSB/RS transmission. Additionally, some embodiments may address the problem of how the WTRU can determine the resources (e.g. time/frequency, etc.) of those infrequent RS to monitor and/or measure.

According to some embodiments, as will be discussed in more detail in the following, a WTRU may perform a mobility event or operation, such as cell switch, handover and/or reselection, to a NES cell (e.g. a cell that is not transmitting always-on SSBs, or cell that is otherwise in an NES state as discussed elsewhere herein) based on configuration information and/or indication(s) received from a serving cell on the beams of (e.g. associated with or indicated by) a first RS configuration (e.g. wide beams including only sync signal(s)) and a second RS configuration (e.g. narrow beams consisting of dynamically triggered SSBs) associated with the NES cell.

In some embodiments, a WTRU may receive configuration information. For example, the configuration information may include first RS configuration(s) (e.g., relating to or associated with wide beams that may include only PSS/SSS) and/or second RS configuration(s) (e.g., relating to or associated with wide beams that may include only PSS/SSS narrow beams that include dynamically triggered SSBs) associated with a NES cell. In other words, the first RS configuration(s) may relate to or be associated with a first type of RS (e.g., SSBs or always-on SSBs), and the second RS configuration(s) may relate to or be associated with a second type of RS (e.g., NES-RS, such as sync signals and dynamic SSBs), or vice versa.

For example, the first RS configuration may include or indicate or more of the following parameters or information: periodicity (e.g., a periodicity associated with a first RS or first RS type), one or more indexes (e.g., index(es) or identifier(s) associated with the first RS or first RS type), and/or an indication of a number of beams (e.g., the number of beams in a burst associated with the first RS or first RS type).

For example, the second RS configuration may include or indicate or more of the following parameters or information: an association between beams associated with the first reference signal configuration and beams associated with the second reference signal configuration, periodicity (e.g., a periodicity associated with a second reference signal or second RS type), one or more indexes (e.g., index(es) or identifier(s) associated with the second reference signal or second RS type), and/or an indication of a number of beams (e.g., the number of beams in a burst associated with the second reference signal or second RS type).

For instance, in some embodiments, the association between the beams associated with the first reference signal configuration and the beams associated with the second reference signal configuration may include, but is not limited to, one or more of the following: a beam (e.g., one wide beam) in (or associated with) the first RS configuration may be associated with one or more beams (e.g., N narrow beams) in (or associated with) the second RS configuration, a QCL or spatial relation information between beams in first RS and second RS configurations (e.g. a mapping or association between an index of a beam in the first RS config and index(es) of N beams in second RS config), and/or timing relation information between beams in first RS and second RS configurations (e.g. timing offset between the end symbol of a beam in the first RS config and the start symbol of N beams in the second RS config).

In some embodiments, the WTRU may receive an indication (e.g. from a serving cell) associated with a first measurement configuration. For example, the WTRU may receive an indication or information to perform measurements on beams in or associated with the first RS configuration that are received from the NES cell. For example, the indication or information may include an identifier or index associated with the first RS configuration (e.g., an ID of one or more first RS) and/or an identifier associated with a NES cell. According to certain embodiments, the indication or information may include an indication of events (e.g. configured threshold values, such as RSRP threshold values) associated with the NES cell.

According to some embodiments, the WTRU may perform measurements on the beams (in or associated with the first RS configuration or first RS type) that are received from a NES cell. For example, in certain embodiments, the WTRU may identify, determine and/or select one or more preferred beams (e.g. a selected beam) in (or associated with) first RS configuration based on measurements (e.g. measurements of signal characteristics). For instance, the WTRU may determine or select one or beams based on RSRP measurements being above a configured threshold or RSRP threshold. As an example, the measurements may be associated with any of L3 (RRC), L2 and/or L1 measurements.

In some embodiments, the WTRU may send a measurement report (e.g. to the serving cell). For example, the measurement report may indicate or include any of measured signal characteristics of the beams associated with the first reference signal configuration (e.g. measurements of beams associated with a first RS type) and/or information associated with the selected beam from among the beams associated with the first reference signal configuration (e.g. a selected beam from or associated with the first RS type). For example, the measurement report may include or indicate any of RSRP measurements made on the beams associated with first RS configuration and/or index(es) or information of (or associated with) at least one selected or preferred beam in first RS configuration. In another example, the measurement report may include or indicate other types of measurements, such as RSRQ measurements, AoA and/or TDoA measurements.

According to some embodiments, the WTRU may receive an indication (e.g. from the serving cell) on a second measurement configuration. For example, the WTRU may receive an indication or information to perform measurements on the beams associated with the second reference signal (e.g. second RS type) that are received from the NES cell. For example, the indication or information may include an identifier or index associated with the second RS configuration (e.g., an ID of one or more second RS or RS type(s)), one or more indexes or identifiers associated with beams associated with the second RS configuration, and/or an identifier associated with a NES cell (which may the same or different NES cell from the one associated with the measurement report discussed above). As an example, the indication may be received in any of L3 (RRC signaling), L2 (MAC CE) and/or L1 (DCI).

According to some embodiments, the WTRU may determine any of the spatial relation and/or timing information for measuring the beams in (or associated with) the second RS configuration (e.g. beams associated with a second RS type) based on the second measurement configuration (or second RS configuration) information and/or based on the indication of the index(es) of beams.

For example, in an embodiment, the WTRU may determine, based on the second reference signal configuration information and on the one or more indexes associated with the beams associated with the second reference signal, a spatial relation for measuring the beams associated with the second reference signal. For instance, the WTRU may determine the spatial filter (e.g., spatial Rx filter) to apply for receiving the indicated beams based on the spatial filter applied for the beams in first RS configuration and/or the spatial relation information (e.g., QCL information). Additionally or alternatively, in an embodiment, the WTRU may determine, based on the second reference signal configuration information and on the one or more indexes associated with the beams associated with the second reference signal (e.g. second RS type), timing information for measuring the beams associated with the second reference signal (e.g. second RS type). For instance, the WTRU may determine the timing for receiving the indicated beams based on the timing of the beams in first RS configuration and the timing relation information discussed above or discussed in detail elsewhere herein.

According to some embodiments, the WTRU may perform measurements on the beams in second RS configuration (e.g. beams associated with the second RS type) that are received from the NES cell.

In some embodiments, the WTRU may send a measurement report (e.g. to the serving cell) indicating any of: the measurements made (e.g. RSRP, RSRQ, AoA and/or TDoA measurements) on the beams, received from the NES cell, which are in or associated with the second RS configuration, and/or information associated with a selected beam from the beams associated with the second RS configuration (e.g. beams associated with the second RS type).

According to some embodiments, the WTRU may perform or cause a mobility event, such as cell-switch, handover and/or (cell) reselection). For example, the WTRU may transmit, based on the determined spatial relation, information in a beam associated with the selected beam from the beams associated with the second RS configuration. For instance, in certain embodiments, the transmitted information may include a PRACH preamble. In an embodiment, the PRACH preamble may be transmitted based on the selected beam (e.g. beam with highest RSRP, RSRQ, SINR, etc.) associated with the NES cell upon receiving a cell switch or handover command from serving cell.

As a result of example embodiments described herein, flexible offloading and/or handover of WTRUs to a NES cell (e.g. cell without always-on SSBs) can be facilitated. Further, example embodiments result in lower energy usage, for example, due to transmitting SSBs from NES cells in two stages (e.g. 1^{st} stage includes only discovery signals and 2^{nd} stage includes dynamic SSBs).

In the following, some of the terminology referred to herein will be explained and may be incorporated, as appropriate, into certain embodiments.

It is noted that terms ‘a’ and ‘an’ and similar phrases are to be interpreted as ‘one or more’ and/or ‘at least one’. Similarly, any term which ends with the suffix ‘(s)’ is to be interpreted as ‘one or more’ and/or ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Synchronization Signal Block or SS/PBCH block may include any one or more of the following: PSS (Primary Synchronization Signal), SSS (Secondary Synchronization Signal), Physical Broadcast Channel PBCH (Data, MIB) and PBCH (DMRS). The SSBs may be transmitted by the NW node (e.g. base station, TRP, relay node, RIS unit) in different directions as beams. The number of SSB beams in an SSB burst set, which may be transmitted periodically within an interval (e.g. 5 ms) may depend on the carrier frequency. For example, an SSB burst may contain 4 SSBs for FR1 (<3 GHz), 8 SSBs for FR1 (3 to 6 GHz) and 64 SSBs for FR2. Certain SSBs may be transmitted as on-demand SSBs (OD-SSBs), which may possibly consist of a subset of SSBs in a burst. Such OD-SSBs may be transmitted aperiodically, semi-persistently, or periodically with certain periodicity. The transmission of such OD-SSBs may be triggered by the NW node or UE (e.g. via transmission of an UL WUS). Some SSBs may include slim/lean SSBs, which may comprise of PSS only, PSS and SSS-only, PBCH or a subset of MIB-only, for example.

Channel state information reference signal (CSI-RS) may include any one or more of the following: CSI-RS resource set (ID), CSI-RS resource (ID/index), resource mapping, power control offset values (e.g. with respect to PDSCH, SSB), scrambling ID, periodicity, offset and QCL info. CSI-RS may be transmitted in DL by the NW node as CSI-RS beams, via different resource types including periodic, semi-persistent and aperiodic.

Channel state information (CSI) may include any one or more of the following: channel quality index (CQI), rank indicator (RI), precoding matrix index (PMI), an L1 channel measurement (e.g. RSRP such as L1-RSRP, or SINR), CSI-RS resource indicator (CRI), SS/PBCH block resource indicator (SSBRI), layer indicator (LI) and/or any other measurement quantity measured by the UE from the configured CSI-RS or SS/PBCH (SSB) block.

Channel conditions may refer to any conditions relating to the state of the radio/channel, which may be determined by the WTRU from: a measurement (e.g., L1/SINR/RSRP, CQI/MCS, channel occupancy, RSSI, power headroom, exposure headroom), L3/mobility-based measurements (e.g. RSRP, RSRQ, s-measure), an RLM state, and/or channel availability in unlicensed spectrum (e.g. whether the channel is occupied based on determination of an LBT procedure or whether the channel is deemed to have experienced a consistent LBT failure).

A property of scheduling information (e.g., an uplink grant or a downlink assignment) may include any one or more of the following: a frequency allocation; an aspect of time allocation, such as time instance or/and a time duration; a priority; a modulation and coding scheme; a transport block size; a number of spatial layers; a number of transport blocks to be carried; a TCI state or SRI; a number of repetitions; whether the grant is a configured grant type 1 (i.e., UE immediately using the configured UL resources after receiving the configuration information), type 2 (i.e., UE waiting until an explicit MAC CE indication before using the configured UL resources) and/or a dynamic grant.

An indication by DCI, or an indication, may include any one or more of the following: an explicit indication by a DCI field or by RNTI used to mask CRC of the PDCCH; an implicit indication by a property such as DCI format, DCI size, CORESET or search space, aggregation level, identity of first control channel resource (e.g., index of first CCE) for a DCI, where the mapping between the property and the value may be signaled by RRC or MAC; and/or an explicit indication by a DL MAC CE.

According to some embodiments described herein, the network or NW may include any of a base station (e.g. gNB, TRP, RAN node, access node, NTN node, IAB node, RIS unit/node), core network function (e.g. AMF, SMF, PCF, NEF) and/or application function (e.g. edge server function, remote server function), for example. For example, NES cells may refer to any of the network nodes that may be operating in an NES state/mode, including any of time, frequency, spatial and/or power domain adaptation modes.

According to some embodiments described herein, NES adaptations may include any of the adaptations at NW in the spatial domain (e.g. power off subsets of antenna ports, elements or panels), time domain (e.g. (de)activation of cell DTX/DRX, apply long periodicity or sparse transmissions of common signals/channels), frequency domain (e.g. disable certain carriers or BWPs) or power domain (e.g. apply lower power offset values).

Some embodiments described herein may include or refer to network availability states, such as cell DTX (or DRX) mode, NES states, NES adaptations, or the like. A NES state or an availability state may refer to a cell state in which the cell, TRP or NW node has activated at least one NES technique or method. For example, this may include one or more of the following: reduced SIB1 transmission (periodic or existence), reduced SSB transmission (periodic or existence), cell DTX, cell DRX, spatial domain adaptation (where a subset of antenna ports and/or elements are turned off), power domain adaptation (where a subset of channels are transmitted with reduced power or muted), triggering of SRS transmission with subset of resources, triggering of subset of TCI states, and/or the cell or TRP has turned off.

A WTRU may determine whether it can transmit or receive on certain resources depending on a network availability state, which implies the gNB's power savings status. An availability state may correspond to any one or more of a network energy savings state, a cell DTX mode, a cell DRX mode, and/or a network node (e.g., gNB) activity level. An availability state can be uplink or downlink specific, and may change from symbol to symbol, slot to slot, frame to frame, or on longer duration granularity. The availability state may be determined by the WTRU or indicated by the network. An availability state can be, for example, “On”, “DL and UL active”, “UL only active”, “off”, “reduced Tx power”, “dormant”, “sleep (de)-activated”, “micro sleep”, “light sleep”, “deep sleep”, the active period of a sleep pattern, the deactivate period of a sleep pattern, and/or the like. In a sleep pattern, the active period may correspond to the time when the NW may actively transmit DL signals/channels and/or the time when the NW may blind decode for UL signals/channels. Such states can be abstracted by NW configuration parameters and/or values, and dynamic indication may point to the active availability state (e.g. by DCI or MAC CE signaling). The “Off” availability state or the non-active period of sleep pattern may imply that the network node's (e.g. gNB's) baseband hardware is completely turned off. The “sleep” availability state may imply that the network node (e.g. gNB) wakes up periodically to transmit certain signals (e.g. presence signals, synchronization, or reference signals) or receive certain UL signals. In some availability states, some DL or UL resources are not available during certain periods of time, and this enables the network to turn off baseband processing and other activities. For example, the WTRU may be configured by RRC with periodic Active and Inactive periods per availability. Some measurement resources (e.g. SSBs or CSI-RS) may be made available just in certain availability states, for example, including any one or more of: RLM, BFD, RRM measurements, CSI-RS feedback configuration, and/or a different power offset for CSI feedback.

Under certain conditions, the WTRU may further transmit a request to the network (wake-up request) to modify the availability state to a state for which resources that would satisfy WTRU requirements are available. The WTRU determines an availability state from reception of availability state indication from e.g. by L1/L2 signaling (e.g. a group common DCI or indication), or may implicitly determine it form the reception of periodic DL signaling-or lack thereof.

The WTRU determines if a resource is available for transmission/reception and/or measurements for the determined network availability state if it is applicable in the active availability state. In addition, the WTRU may also adapt its active C-DRX cycle, active spatial elements (e.g. antenna or logical ports), active TRPs, paging occasions as a function of the signaled or determined availability state. The UE may be configured with one or more sets of NES transmission and/or reception parameters per availability state, e.g. by broadcast or dedicated configuration signaling. The WTRU may apply the NES parameter set according to the determined or signaled availability state. The WTRU may apply one or more applicable configurations depending on the determined NES state. A set of NES parameter may include any one or more of: a number of antenna ports, a C-DRX configuration, a measurement configuration (e.g. for RRM, RLM, and/or BFD), CSI feedback, a CSI-RS configuration, an SSB configuration, CHO or mobility candidates, a set of active TRPs, and/or the like.

An availability state may be applicable to at least one transmission, reception, or measurement resource. An availability state may be applicable to at least one time period such as a time slot or time symbol. An availability state may be applicable to a serving cell, a cell group, a frequency band, a bandwidth part, a TRP, a set of spatial elements, or a range of frequencies within a bandwidth part. For example, when an NES state changes in a cell, the UE may receive an availability state change indication indicating that this change is just for that cell, for all cells at the same frequency, and/or same RAT.

The WTRU may consider the active availability state associated with a cell, carrier, TRP, or frequency band to be “Off”, “Deep sleep”, or “Micro sleep” after reception of a DL signaling that changes the cell's or TRP's availability state. For example, the WTRU may receive a turn off command on broadcast signaling, RRC signaling, DCI (e.g. a group common DCI), or a DL MAC CE (e.g. indication part of PDSCH). The WTRU may determine an availability state from reception of availability state indication from e.g. by L1/L2 signaling (e.g. a group common DCI or indication) or broadcast signaling associated with an availability state. For example, an availability state change indication could also be part of SI update or SIB signaling (e.g. in a separate SIB that is not read by legacy UEs). There can be a common time for all UEs in the cell to determine availability state status. For example, the WTRU may determine a change of NES state change from the reception of a group common command L1 signaling (e.g., a group common DCI, a multi-stage DCI, a specific DCI format, or a DCI scrambled by a configured or specified NES-specific RNTI). L1 signaling may indicate one of the configured NES parameters sets to apply or may determine a delta configuration from the current set of parameters upon determining an NES state change. The WTRU may transmit feedback/acknowledgment to gNB, possibly multiplexed with UL data (e.g., part of an UL TB as a MAC CE or a sub-header indication), following the reception of NES state change indication. For example, the WTRU may determine a change of NES state change from the reception of broadcast signaling associated with NES state indication or change, including signaling in SIB(s) or part of a broadcast or multicast PDSCH. The UE may be indicated the NES state explicitly in the SIB. The WTRU may be configured with one or more SIBs exclusively associated with configuration of NES parameters. The WTRU may be configured to receive such broadcast or multicast indication periodically; the WTRU may determine an indication is mis-detected if not received on expected periodic occasions, if a number of misdetections is counted, and/or if a timer has elapsed since the last reception of the NES state indication. The WTRU may start inter-cell, inter-frequency, and/or inter-RAT measurements, start a mobility procedure, and/or start evaluating configured CHO candidates following the determination of a misdetection of the NES state indication.

The WTRU may implicitly assume a certain availability state associated with a cell, carrier, TRP, or frequency band (e.g., “Off, ”deep sleep“, ”micro sleep“ or dormant”) from any one or more of the following.

The availability state may be determined from reception of a command or signal indicating a change in availability state: e.g., a group common DCI in connected mode or RRC signaling or a presence signal. The WTRU may determine an availability state implicitly form the reception of periodic DL signaling. The WTRU may be configured or specified to associate an availability state with one or more DL signal type (e.g., SSB, partial SSB, and/or one or more periodicity.

The availability state may be determined from reception of a paging message, paging DCI, paging PDSCH, or a paging related signal (e.g., PEI), possibly on a subset of POs (e.g., those aligned with NES drx cycle or a configured subset of PDCCH resources). The WTRU may assume a certain availability state after reception of an indication part of the DCI or PDCCH scheduling paging (e.g., as a function of the P-RNTI, NES-RNTI or based on receiving an explicit indication -e.g., on a reserved bit). The UE may assume a certain availability state after the reception of a paging message with a certain P-RNTI, a separately configured NES P-RNTI, or the NES group RNTI. The UE may assume a certain availability state after the reception of a paging message with a certain P-RNTI. The UE may be configured with one more PEI subgroup for NES, where a subgroup may be associated with one or more availability state. The UE may assume a certain availability state after reception of a PEI with an NES subgroup, possibly if that subgroup is configured and/or associated with the availability state. The indication of the availability state or the availability state switch may be indicated in the paging payload, e.g., as a flag part of the paging message or the short message. Such paging indication may further indicate an alternative cell to monitor paging on while the cell from which the signaling was received is off, sleep, or in NES state. Such paging indication may further indicate or signal applicable reconfiguration parameters (e.g., for initial access, applicable PRACH resources, applicable SSB/RS occasions, applicable SI cycle, and/or the applicable cell(s) and associated availability states).

The availability state may be determined from Reception of TCI state indication, indicating the activation/deactivation or triggering of one or more TCI states. Such TCI state may include in on QCL sources (e.g. SSB, on-demand SSB, slim/lean SSB, TRS, CSI-RS resource, SRS resource, PRS, SRSp), QCL types (e.g. info on doppler shift, doppler spread, delay spread, average delay, spatial Rx parameter) and spatial config info (e.g. parameters for UL Tx spatial filter).

The availability state may be determined from the network (e.g. gNB) DTX status (whether the gNB is in active time or an associated activity timer is running).

The availability state may be determined from lack of detection of a presence indication. For example, the WTRU may determine an availability state associated with the cell (e.g., “off” or “deep sleep”) if presence indication was not detected on one or more presence indication occasion. For example, the WTRU may assume or change the cell's availability state after a number of consecutive misdetections or after timer expires following no detection of a presence signal. The WTRU may determine an availability state is active or de-active after expiry of a timer associated with the availability state. Such timer can be configured and/or maintained in connected mode only, or also in other states (e.g., idle and inactive states). For example, the WTRU may determine an availability state implicitly form the lack of reception of periodic DL signaling. For example, the WTRU may be configured with a signal quality threshold (e.g., an RSRP threshold) and if the WTRU does not detect a signal associated with an availability state (e.g., a presence signal or an SSB) with a signal strength above the threshold, the WTRU may assume that this availability state is not active and may assume a different availability state. This criterion can be also coupled with lack of detection of an identifying sequence of the presence signal (e.g., detection of the PSS sequence for example).

The availability state may be determined based on time in the day. For example, the WTRU may be configured to automatically assume a certain availability state (e.g. off, sleep, or dormant) for a configured subset of cells (e.g. capacity boosting cells) depending the time in the day. For example, the UE may determine that a capacity boosting cell has an availability state as “On” in certain hours of the day, “Deep sleep” in other configured hours, and “Off” in a third set of configured hours of the day or night.

The availability state may be determined based on the availability state of an associated cell (e.g. another carrier of the same MAC entity, another carrier in the same cell group, another carrier in the same network node (e.g. gNB), another sector in the same network node (e.g. gNB), or a configured associated cell or capacity boosting cell).

The availability state may be determined based on detection of a PSS only signal or a simplified/stripped down SSB signal, detection of an RS signal (e.g. CSI-RS, PRS, TRS) or the lack thereof, the UE's RRC state (Idle, inactive, or connected mode), whether paging has been received (e.g. possibly within a configured time window), whether system information (e.g. periodic SI or a subset of SIBs) have been received (e.g. possibly within a configured time window), and/or measured channel condition(s) being below or above a threshold. For example, the WTRU may assume a change of NES state based on a change of measured channel conditions or making a channel measurement below or above a threshold. For example, the WTRU may use degradation in measurements of SSBs or CSI-RS, possibly in combination with other signaling, e.g., to determine the NES state. For example, a configured window following the DCI reception can be used to measure SSBs and/or CSI-RS for degradation, and if a delta of SSB-RSRP drop is measured the WTRU may determine that the NES state has changed and assume associated actions for such NES state (e.g. trigger for CHO candidate selection or for group scheduling for a mobility command).

The WTRU may be configured to monitor an indication that may characterize the level of network activity (e.g. an availability state). The network activity may be associated with a network node (e.g. gNB) and/or a cell. The WTRU may assume the same availability state for all cells that are part of the same node (e.g. gNB), or cells of the same MAC entity. The network activity indication (e.g. the presence indication) may include a channel (e.g., a PDCCH) and/or a signal (e.g., a sequence). The activity indication or the NES state change indication/command may indicate the level of activity the WTRU may expect from the associated node, gNB and/or cell, e.g., reduced activity. The activity indication may contain activity information of other nodes, gNBs and/or cells. The activity indication may be a PDCCH containing group common signaling. For example, the NW may transmit a group common DCI to a group of WTRUs (e.g. UEs in the serving cell) indicating a change of an activity state or activity level in UL and/or DL. The CRC of the PDCCH may be scrambled with a dedicated “activity indication RNTI or an NES-RNTI”. A WTRU may be configured with at least one search space associated with the monitoring occasions of the activity indication PDCCH. The indication may include a go-to-sleep signal, e.g., a predefined sequence. When a WTRU detects this sequence, the WTRU may expect a reduced activity level over a specific time duration. The WTRU may activate C-DRX for the period of time indicated. Alternatively, two sequences may be used to indicate regular activity and reduced activity. The signaling within the PDCCH or the activity indication may contain any one or more of the following.

For example, the signaling may include expected activity level of the associated gNBs/cells over a specific time interval (e.g. an availability state). The activity levels may be predetermined and/or configured and may, for example, consist of regular and reduced activity. The signaling may indicate the activity level. For example, bit “1” may indicate regular activity and bit “0” may indicate reduced activity.

For example, the signaling may include, for each activity level (e.g. availability state), transmission and reception attributes may be defined. For example, during reduced activity, UE may not be expected to monitor certain PDCCH search spaces (including all SSs), and/or receive a certain type of PDSCH (including all PDSCH), and/or transmit PUCCH/PUSCH, and/or perform certain measurements. The UE may start or stop monitoring PDCCH and/or TCI states associated with determined NES state, including PDCCH resources or TCI states associated with (de)activated TRPs or spatial elements.

For example, the signaling may include a set of configurations may be associated with an activity level and may be used/applied when that activity level is indicated (e.g. an NES parameter set). For example, SS configurations, CSI reporting configurations, indices of transmitted SSBs, etc. Each set of configurations may have an attribute associated with an activity level. For example, a tag that can be set to “reduced activity”.

For example, the signaling may include the time interval over which an activity level is assumed may be signaled in the PDCCH or part of the activity indication. The time interval may be indicated using a bitmap where each bit in the bitmap may be associated with a specific duration, e.g., a slot or a frame. For example, bit “1” may indicate regular activity and bit “0” may indicate reduced activity on an associated frame. The time interval may be indicated with a start time and length of interval. The start time may be defined; for example, it may be determined by adding a fixed offset to the time the indication is received. The length of the interval may be configured or signaled in the indication PDCCH. The time interval over which an activity level is assumed may be predetermined. The UE may assume an interruption delay (or more generally a time till the NES state changes) after the NES state change command reception (e.g. after the last symbol or slot on which the command was received). The interruption time can be in absolute time, a number of symbols, or a number of slots.

The WTRU may determine that an uplink or downlink resource or signal is available for transmission/reception and/or measurements for the determined network availability state if it is applicable in the active availability state. The WTRU may determine that a subset of measurement resources and/or signals (e.g. SSBs, CSI-RS, TRS, PRS) are not applicable in certain availability states. The WTRU may determine that a subset of uplink or downlink resources (e.g. PRACH, PUSCH, PUCCH) are not applicable in certain availability states. The WTRU may transmit some uplink signals only in a subset of NW availability states (e.g. SRS, SRSp, PRACH, UCI).

Some example embodiments described herein may use or refer to the terms network NES state and cell NES state interchangeably. A WTRU may know the cell NES state for one or more cells, e.g., through network configuration and indication. When used as network NES state, it means the NES states of one or more cells which could be serving cells, neighbor cells etc. A NES state may imply an activation state only for a NES state, while another NES state may correspond to the deactivation state. The terms network availability state, cell turned off, SIB1-less operation, reduced SIB1/SSB periodicity state, (de)-active cell DTX mode/configuration, or NES state may be used interchangeably. The WTRU may determine an SSB/SIB1 transmission state (whether they are transmitted and/or periodicity) implicitly from a determined active availability state, and vice-versa. Herein, a NES cell may refer to a cell that is applying at least one NES technique, is in a NES state (e.g. activated NES state), and/or is capable or configured to apply an NES technique at some point. Therefore, a non-NES cell may be used to refer to any cell that is not designated as a NES cell per this definition (e.g. not in a NES state or cannot/doesn't apply a NES technique). In one alternative, the designation of which cell that can be NES cells may be configured (e.g. by broadcast or dedicated signaling).

In one or more NES state(s), the WTRU may transmit a wake up signal (e.g. PRACH, SR, PUCCH, UCI on PUCCH, a MAC CE or UE assistance information, SRS resource) to request a change in the NES state, additional UL or DL resources, reception of on demand SSB, reception of on demand SIB1/SI, or activation of a given cell (e.g. on that is in a NES state). Triggers for the WTRU to transmit a wake-up signal and/or request reception of an on demand SSB may include any one or more of the following: detection of a reference signal, detection of a change of TCI state, making a channel measurement on the cell or an associated cell less than or greater than a threshold, arrival of new data (possibly for a given LCH/LCG), amount of buffered data exceeding a threshold (possibly for a given LCH/LCG), based on positioning being within a given range, based on triggering BSR/SR, based on triggering a L3 mobility events, based on the UE or cell DTX/DRX status, based on expiry of a timer, and/or the UE receiving request from higher layers to transmit on-demand SSB request.

A WTRU may transmit or receive a physical channel or reference signal according to at least one spatial domain filter. The term “beam” may be used to refer to a spatial domain filter. The WTRU may transmit a physical channel or signal (e.g. PUCCH, PUSCH, SRS) using the same spatial domain filter as the spatial domain filter used for receiving an RS (such as CSI-RS) or a SS block. The WTRU transmission may be referred to as “target”, and the received RS or SS block may be referred to as “reference” or “source”. In such case, the WTRU may be said to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be said to transmit the first (target) physical channel or signal according to a spatial relation with a reference to the second (reference) physical channel or signal. A spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI or configured by RRC. In another example, a spatial relation may be configured by RRC for an SRS resource indicator (SRI) or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such association may exist between a physical channel such as PDCCH or PDSCH and its respective DM-RS. At least when the first and second signals are reference signals, such association may exist when the WTRU is configured with a quasi-colocation (QCL) assumption type D between corresponding antenna ports. Such association may be configured as a TCI (transmission configuration indicator) state. A WTRU may be indicated an association between a CSI-RS or SS block and a DM-RS by an index to a set of TCI states configured by RRC and/or signaled by MAC CE. Such indication may also be referred to as a “beam indication”.

As discussed herein, an SSB may refer to one or more SSB beam (spatial relation) within a collection of SSBs (SSB burst). An SSB may refer to a beam-and vice-versa-or a CSI-RS resource related to the beam. SSB, SSBs, and/or SSB burst may loosely refer to one or more beams transmitted from a TRP or a NW node. In some embodiments described herein, the terms ‘RS’, ‘RS beams’, ‘SSB’ and ‘SSB beams’ may be used interchangeably. Also, the terms ‘RS config, ‘RS beam config’, ‘NES-RS config’, and/or ‘SSB config’ may be used interchangeably.

It is noted that, in some embodiments, the terms ‘first RS’, ‘first RS type’ and ‘first type of RS’ may be used interchangeably. Similarly, in some embodiments, the terms ‘second RS’, ‘second RS type’ and ‘second type of RS’ may be used interchangeably. Examples of types of RS are discussed below as well as elsewhere herein.

In some embodiments as discussed on more detail elsewhere herein, a WTRU may receive configuration information, and/or sub-configurations (e.g. subset of parameters associated with a configuration, update to configurations) associated with one or more reference signals (RS). Such RSs, applicable in DL and/or UL, may include any one or more of the following: SSB, enhanced RS, measurement RS (e.g. CSI-RS, TRS, PTRS), NES-RS, light-RS. For example, SSB may include legacy NR SSBs including cell defining SSBs (CD-SSB) or non-cell defining SSBs (NCD-SSBs), and/or SSBs that are on sync raster and off sync raster. For example, enhanced RS may include new RS/SSBs that may include additional/lower set of resources/signals/parameters than those in legacy SSBs, including a combination of PSS/SSS, MIB, PBCH, pre-SIB1, SIB1, RACH config, UL WUS config, PUCCH resource config, SDT resources, SRS resources, etc. Measurement RS may include, for example, CSI-RS, TRS, PTRS. For example, NES-RS may include any one or more of: on-demand SSBs (OD-SSBs) that may be available in a certain duration/window with certain periodicity/inter-burst gap, from a start time onwards, and/or WTRU/group-specific RS (e.g. a set of RS beams that may be triggered/transmitted for a UE/UE group). For example, light-RS may include any one or more of: RS that contain a combination of one or more sync signals, PSS, SSS, discovery reference signal (DRS), PBCH only, and/or SIB1 only, etc.

Such configuration for RS (RS config) may be applicable for supporting one or more NES adaptations in different any of time, frequency, spatial and power domains, for example. Such configurations/parameters may be applicable for any of the solutions described herein. In examples described herein, the terms ‘NES-RS’, ‘Enhanced RS’, ‘measurement RS’ and ‘light RS’ may be used interchangeably when referring to any reference signals that may or may not be identical to the legacy SSBs..

For example, the configurations/sub-configurations associated with RS, at least in part, may be received in broadcast transmission (e.g. MIB, SIBx) or in dedicated RRC signaling (e.g. in RRCReconfiguration message) during CONNECTED mode or in INACTIVE/IDLE mode (e.g. RRCRelease message, when transitioning from CONNECTED mode to INACTIVE mode). Alternatively or additionally, the configuration/sub-configurations may be received by the WTRU, at least in part, in one or more dynamic signaling indications (e.g. in MAC CE or DCI) or in NES/cell activity indications, for example. Such NES/cell activity indications may be received in RRC signaling, MAC CE, DCI (e.g. UE-specific or group common DCI) or PDSCH, for example. In an example, the WTRU may receive a first subset of parameters associated one or more RS configs in RRC signaling and a second subset of parameters or update to the parameters in the first subset may be received in dynamic signaling (e.g. MAC CE, DCI).

In some embodiments, the WTRU may receive, e.g., in configuration info, one or more of the following parameters associated with the RS configuration or RS sub-configurations: indexes/IDs of one or more RS configurations, RS resource sets and/or resources, RS ports (e.g. number and set of Tx and/or Rx ports), resource type (e.g. corresponds to the time-domain behavior of RS resource config which may be periodic, semi-persistent, or aperiodic, usage type (e.g. WTRU may be configured with any of beam management, RLM, NES, codebook/non-codebook, antenna switching for using such RS), slot level periodicity and/or slot level offset (e.g. for periodic or semi-persistent RS), RS resource/beam bandwidth, frequency hopping information, guard period (e.g. Number of symbols/slots/ms. WTRU may apply the guard period when switching between different RS configs/sub-configs or when switching between different Rx ports for the RS reception), RS comb pattern information, comb offset hopping pattern with repetition, RS sequence type/ID (e.g. m-sequence, Zadoff-Chu sequence), power control (PC) parameters (e.g. PC parameters may include alpha, p0, power per RS block, pathloss reference RS, and/or RS power control adjustment states (e.g. closed loop factor)).

For example, RS resources may include any one or more of the following: time domain resources, spatial domain resources, resources that may or may not overlap with resources of other RS configurations, resources that correspond to a RS resource pool. For example, time domain resources may include or may indicate any of: the number of symbols per slot (e.g. 1, 2, 4 symbols per slot), start offset symbol, repetition factor, burst periodicity, duration/window of RS transmission, time gap between beams/RS/bursts, and/or comb/interleaving pattern. For example, frequency domain resources may include or may indicate any of: number of PRBs, start offset PRB, repetition factor, and/or comb pattern. For example, spatial domain resources may include or may indicate any of: the number of RS/beams in a burst, position of RS in a burst (e.g. bitmap), beamwidth of RS beams (e.g. wide-beams, narrow beams). For example, each RS config/sub-config may include resources which may or may not overlap with the resources in other RS configs/sub-configs, for example. In an example, the resources allocated for one or more RS configs/sub-configs may correspond to an RS resource pool.

For example, for frequency hopping information, the WTRU may be configured with one or more hopping patterns that may be applied over a set of RS resources in any of the time, frequency, and spatial domains. In a hopping pattern, a partial set of RS resources in frequency domain (e.g. PRBs) may be used in each time domain resource (e.g. symbol) for transmitting/receiving the RS using different spatial relation. Such hopping pattern may correspond to one or more NES adaptation/state, for example.

For example, with respect to RS comb pattern information, a parameter may include transmission comb value, which may be associated with the gap in terms of the number of PRBs or number of symbols/slots between two RS resources in the frequency and/or time domains. Each RS config may include one or more RS comb patterns, where each pattern may be associated different set of parameters (e.g. offset value, cyclic shift) and/or RS resources in time/frequency/spatial domains. A comb pattern may include RS resource in different symbols (within one slot or across multiple slots) or slots, where the RS in different symbols/slots may be received with different spatial relation/filter. When RS is configured with periodic or semi-persistent RS resources, the RS comb pattern (e.g. using resources in time, frequency, spatial domains) may be repeated in each period. When RS is configured with aperiodic RS resources, the RS burst may consist of RS resources in time, frequency, spatial domains.

In some embodiments, the UE may be configured with any one or more of the following properties/parameters on TCI states associated with the reference signals (RS): property associated with quantity, property associated with RS config/sub-config, property associated with triggering, and/or parameters associated with TCI states.

A property associated with quantity may include one or more TCI states (e.g. indicated by index/ID) may be associated with a set or pool (e.g. indicated by a pool ID). Each TCI state may be associated with one or more reference signals (e.g. SSB, NES-RS, CSI-RS, TRS, SRS) as a QCL source.

A property associated with RS config/sub-config may include any one or more of the following: each RS config/sub-config may be associated with one or more TCI states, one or more RS configs/sub-configs be associated with a common pool of TCI states, TCI states in different RS sub-configs may be non-overlapping (e.g. RS config1 may be associated with TCI states {TCI1, TCI2} and RS config2 may be associated with TCI states {TCI3, TCI4}).

A property associated with triggering may include any one or more of the following: the one or more TCI states may be activated/deactivated upon configuration (e.g. via RRC signaling) or with dynamic signaling (e.g. MAC CE and/or DCI). The granularity of TCI state (de)activation may be done on the basis of: per TCI state, per-TCI state pool, per RS-config, per RS-sub-config.

The parameters associated with TCI states may include any of the following: QCL sources (e.g. IDs/indexes (e.g. RS id/index, SSB index, NES-RS index, CSI-RS resource ID), type of resource/signal (e.g. periodic, semi-persistent, aperiodic, on-demand, slim/lean), e.g., each TCI state may be associated with a RS resource/beam as a QCL source or reference signal/beam for determining the spatial relation), QCL types (e.g. Type A (doppler shift, doppler spread, average delay, delay spread), Type B (doppler shift, doppler spread), Type C (average delay, doppler shift), Type D (spatial Rx)), and/or validity conditions. The validity conditions associated with one or more TCI states may include time validity, location/spatial validity, or (de)activation signaling. For instance, time validity may indicate the validity duration from the reception of the configuration or triggering indication (e.g. start of a timer) to the end of the duration (e.g. end of a timer) during which the UE may assume the configured/indicated TCI state(s) are valid. For example, location/spatial validity may indicate the ID list of the cells/TRPs/NW nodes whose coverage in which the UE may assume the configured/indicated TCI state(s) are valid. For instance, the UE may assume a TCI state as valid when receiving signaling indicating TCI state activation, and as invalid when receiving signaling indicating TCI state deactivation. Any of the validity conditions above may be applicable for determining the validity of the RS configs, for example. When any of the validity conditions are not met, the WTRU may release the TCI states and/or send a request indication for new/updated TCI states.

According to some embodiments, a WTRU may receive, in configuration info, any of the following events, conditions and/or threshold values for selecting or using any of the RS configs/sub-configs, RS resources, and TCI states for RS: measurement threshold values (e.g. the threshold values may correspond to EPRE, RSRP, RSRQ, SINR, CQI, etc. For example, the UE may select an RS (e.g. to replace another RS that may be switched off), when the measurements made on an associated/replacement RS/TCI state is higher/lower than a RSRP threshold), timing information, transmission/reception power, priority, and/or events.

For example, the timing information may include a start time threshold, an end time threshold, and/or a time window. For example, with respect to a start time threshold, an RS resource/beam may be received if it begins no later than a start time T1 symbols/slots/ms after the UE receives an indication associated with activation of the RS config to which the RS resource belongs. For example, with respect to an end time threshold, an RS resource/beam may be received if it ends no earlier than an end time T2 symbols/slots/ms after the UE receives an indication associated with activation of the RS config to which the RS resource belongs. For example, with respect to the time window (e.g. start offset time, length), the WTRU may use one or more RS configs that may be accommodated within the time window for RS transmission.

For example, the transmission/reception power conditions or values may include a Tx power threshold and/or power spectral density (PSD) threshold. For example, with respect to Tx power threshold, the WTRU may use one or more RS resources (e.g. in time domain and/or frequency domain) if the transmit/receive power (e.g. total power in RS resources in a transmission instance) is less than a first power threshold value and/or greater than a second power threshold value. For example, with respect to power spectral density (PSD) threshold, the WTRU may use one or more RS resources (e.g. in time domain and/or frequency domain) if the PSD over the RS resources is less than a first PSD threshold value and/or greater than a second PSD threshold value. For example, with respect to priority, one or more priority values may be associated with any of RS configs, RS resources, RS parameters and TCI states. For example, the UE may use an RS config, when the priority associated with the RS config is higher than a priority threshold value and/or lower than another priority threshold value. For example, with respect to events, these may include any of change of RSRP measurements of RS (e.g. when NW does NES adaptation), indication of TCI state(s) changes, and/or detection of RRM/BM/mobility events (e.g. HO, RLM, RLF events).

In some embodiments, a WTRU may receive configuration and/or sub-configurations associated with one or more cells (e.g., network node(s), TRP(s), gNB(s)) in a multi-cell deployment. Such configuration info may include any of the following: one or more configuration(s) associated with a NES cell (e.g. cell A in FIG. 2) and/or one or more configuration(s) associated with a coverage and/or anchor cell (e.g. cell B in FIG. 2).

According to some embodiments, the WTRU may receive the configuration associated with an NES cell (e.g. Cell A supporting CONN mode UEs and/or not supporting initial access and/or initial cell selection procedures). The configuration associated with the NES cell may include, indicate or refer to any one or more of the following: resources associated with NES cell (e.g. resources in any of time, frequency, spatial and power domains that may be optimized for energy savings and operations/procedures associated with CONN mode UEs), reference signal transmitted by the NES cell, etc.

With respect to the reference signals transmitted by the NES cell (e.g. Cell A), Cell A may not transmit SSBs or may transmit SSBs with long periodicity (e.g. for energy savings). Cell A may transmit sync signal, NES-RS (e.g. OD-SSB), and/or measurement RS (e.g. CSI-RS) for example to support time/frequency synchronization, RRM, RLM/BM, etc. Sync signals may be transmitted in wide beams (e.g. wide beamwidths). NES-RRS and/or SSBs may be transmitted in narrow beams (e.g. narrow beamwidths). The WTRU may not monitor search space (SS-0) or control resources in CORESET-0 for SIB1/SIBx when in CONN mode. The WTRU may receive any SI update info in user specific search space and/or in RRC signaling. The WTRU may receive NES-RS in or out of sync raster. For example, UE may receive the NES-RS on ARFCN channels that may be known to UE or dynamically indicated to UE. The WTRU may send an UL WUS signal to Cell A for requesting SSBs/NES-RS/SIBx, possibly in scenarios when such RS/beams are not transmitted for transmitted with long periodicity.

In some embodiments, NES cell (e.g. Cell A) may undergo at least some of the following NES adaptations: SSB adaptation in time domain (e.g. from transmission using long periodicity to transmission using short periodicity and vice-versa) and/or cell mode transitioning (e.g. from non-initial access-based to initial access-based and vice-versa).

According to some embodiments, the WTRU may receive the configuration associated with a coverage and/or anchor cell or node (e.g. Cell B). Cell B may support initial access and/or cell (re)selection procedures, cell B may support both IDLE and CONN UEs or only IDLE UEs (e.g. for camping, paging, initial access), and/or cell B may provide wider coverage (e.g. One or more Cell As may be overlaid over Cell B). The configuration associated with the coverage and/or anchor cell/node (e.g. cell B) may include, indicate or refer to any one or more of the following: reference signals transmitted by cell B and/or resources associated with cell B.

For example, with respect to the reference signals transmitted by Cell B, Cell B may transmit any of the SSBs (e.g. for time/frequency sync, initial access) and/or NES-RS (e.g. sync signals for enabling sync before paging). Any of the SSBs and/or NES-RRS may be transmitted in wide beams (e.g. when operating is NES mode) or in narrow beams (e.g. during high load conditions). For example, the WTRU may receive the UL WUS config for Cell A in any of the SIBx of Cell B. In some examples, Cell B may undergo the following NES adaptations: transmission of wide beam SSB to narrow beam SSB, e.g. during high load, transmission of wide beam SSB to narrow beam NES-RS, e.g. during surge in CONN mode UEs, transmission of narrow beam SSB to wide beam SSB, e.g. during low load, and/or transmission of narrow beam NES-RS to Wide beam SSB, e.g. during low load.

According to example embodiments described herein, the terms “NES Cell” and “Cell A” may be used interchangeably. Additionally, the terms “Coverage cell”, “Anchor Cell” and “Cell B”may be used interchangeably.

As introduced above and discussed in more detail in the following, some example embodiments may be directed to or may include methods or operations for enabling mobility of a WTRU, such as by cell switching, handover and/or reselection. For example, certain embodiments can provide methods that facilitate the mobility or movement of the WTRU to a cell without always-on reference signals. FIGS. 2A-2C illustrate an example system depicting procedures according to some example embodiments. For example, FIGS. 2A-2C illustrate an example of a WTRU performing a mobility event, such as cell switching, handover and/or cell reselection, based on measurements on NES-RS received from a NES cell.

In some embodiments, the WTRU may perform or determine to perform a mobility event, such as cell switch, handover and/or reselection, to a NES cell (at least) based on the configuration information on (e.g. relating to or associated with) the RS beams associated with the NES cell (e.g. sync signal config, NES-RS config) and indications associated with measurement configurations, possibly related to measurements on the RS beams received from the NES cell. Such an NES cell may not be transmitting the always-on SSBs or may be transmitting SSBs with long periodicity for energy savings. The WTRU may receive the configuration information and indications from a serving (or anchor) cell, which may be different than the NES cell. For example, such configurations/indications received from the serving cell may be related to the beams of a first RS configuration(s) (e.g. wide beams consisting of only sync signal) and a second RS configuration(s) (e.g. narrow beams consisting of dynamically triggered SSBs) associated with the NES cell.

According to some embodiments, as illustrated in the example of FIG. 2A at 201, the WTRU may receive configuration information from NW (e.g. from serving cell) associated with the RS beams transmitted by one or more NES cells. Such configuration information may be received, entirely or in one or more parts, in any of L3/RRC signalling (e.g. broadcast/SIB or dedicated signals), L2/MAC signaling (e.g. MAC CE) or L1/PDCCH (e.g. DCI) indications. Such configuration information may include any one or more of, or any combination of, one or more of the following: RS config associated with sync signals (e.g. first RS config), RS config associated with NES-RS (e.g. second RS config), application time/delay, frequency band and control resources associated with existing and replacement RS beams, validity info associated with RS configuration(s), and/or NES states/modes.

With respect to the RS config associated with sync signals (e.g. first RS config), for example, one or more sync signals may be received by a WTRU in wide beams or narrow beams. Such sync signals may include any of PSS-only, SSS-only, PSS/SSS-only or any other signal/sequence that may be used for synchronization/measurements. The parameters associated with the sync signal may include or indicate any one or more of the following: IDs/Index(es) of RS beams in a burst, number of RS beams in burst, position of RS beams in burst (e.g. a bitmap may indicate which of the beams that are active/inactive in a burst), sequence type (e.g. id/index associated with sequence), RS resources in any of time, frequency, spatial domains for measurements (e.g. any of L3, L2, L1 measurements), periodicity (e.g. for periodic RS config), timing information (e.g. including any of start offset, start/end time for RS beam transmission, time duration/window during which RS beams are available, time gap between RS beams and between bursts, e.g., for semi-persistent or aperiodic RS config).

With respect to the RS config associated with NES-RS (e.g. second RS config), for example, one or more NES-RS beams may be received by a WTRU in wide beams or narrow beams. Such NES-RS beams may include any one or more of the following: dynamically triggered SSBs (e.g. OD-SSBs), measurement RS (e.g. CSI-RS), light RS, enhanced RS, that may be used for any of synchronization, measurements (e.g. L3, L2, L1), RLM, beam selection, cell-switch, etc. The parameters associated with the NES-RS beams may include or indicate any one or more of the following: type of NES-RS (e.g. id/index associated with type of SSBs such as SSG type “legacy” or SSB type “new”), IDs/Index(es) of RS beams in a burst, number of RS beams in a burst, position of RS beams in a burst (e.g. a bitmap may indicate which of the beams that are active/inactive in a burst), set of active beams in burst (for example, in spatial domain, only a subset of the RS beams in a burst may be transmitted, possibly those in the direction of the UE), Tx power of RS beams (for example, in power domain, a subset of RS beams may be transmitted with a first power level and another subset of RS beams may be transmitted with a second power level), RS resources in any of time, frequency, spatial and power domains for measurements (e.g. any of L3, L2, L1 measurements), periodicity (e.g. for periodic RS config), timing information (e.g. including any of start offset, start/end time for RS beam transmission, time duration/window during which RS beams are available, time gap between RS beams and between bursts, e.g. for semi-persistent or aperiodic RS config), and/or priority/importance values of RS beams.

In some embodiments, the RS config associated with NES-RS may include or indicate association information indicating the association between the RS beams in first RS config (e.g. sync signals) and RS beams in second RS config (e.g. NES-RS beams). For example, the association information may include or indicate that a (e.g. one wide beamwidth) sync signal/beam in the first RS config may be associated with one or more, or two or more, (e.g. N narrow beamwidth) NES-RS beams in the second RS config. Additionally or alternatively, for example, the association information may include or indicate QCL or spatial relation info between the beams in the first RS config and second RS config. Such QCL/spatial relation info may be provided as a mapping info between an id/index of a sync signal/beam in first RS config and id/indexes of N beams in second RS config. For example, an RS beam (sync signal) with index i in the first RS config may be associated with a set of RS beams (NES-RS) with indexes {a, b, c, d, e} in the second RS config. In this case, the set of RS beams {a, b, c, d, e} may fall within the beamwidth or coverage of RS beam i and/or may be transmitted from the same/similar set of antenna elements/ports/panels at NES cell. The UE may use the same/similar spatial relation (e.g. spatial Rx filter) for receiving both RS beam i and any beams within the set of RS beams {a, b, c, d, e}. Additionally or alternatively, for example, the association information may include or indicate timing relation info between the beams in the first RS and second RS configurations. Such timing relation info may be provided as a timing offset/gap between the last symbol/slot of a sync signal/beam in a burst (e.g. in first RS config) and the first symbol/slot of the first of N NES-RS beams in a burst (e.g. in second RS config), for example. For example, the timing of a sync signal/beam (e.g. last symbol/slot of a sync signal in a burst of first RS config) may be T1 and the timing of the NES-RS beam (e.g. first symbol/slot of the first NES-RS beam in a burst of second RS config) may be T2=T1+offset.

With respect to application time and/or delay, the WTRU may be configured with one or more application time and/or delay values, which may indicate a time duration starting with the time instance (e.g. symbol/slot) from the reception of an indication indicating the start/triggering of the RS beams to the time instance when the RS beams are actually available/transmitted. Such application time/delay may be associated with the sync signals (first RS config) and NES-RS beams (second RS config). In examples, the application time for synch signals may be the same or different than those of NES-RS beams.

With respect to frequency band and control resources associated with existing and replacement RS beams, the WTRU may be configured with any of the frequency band/BWP info where the RS beams (e.g. associated with first and/or second RS configs) may be received, sync raster info (e.g. ID/index of sync raster where the RS beams may be located) and control resource set (CORESET)/PDCCH monitoring config where the control indications associated with the RS beams may be received. For example, when the frequency resources for the RS beams in the first RS config and second RS configs may be located in different bands/BWPs, the WTRU may switch to a corresponding band for receiving the associated RS beams. The WTRU may also switch from a first PDCCH monitoring config associated with the first RS config to a second PDCCH monitoring config associated with the second RS config, possibly for receiving any control indications (e.g. DCI) associated with the RS beams, for example.

With respect to validity information associated with RS configuration(s), the WTRU may be configured with validity info associated with the first and second RS configs. Such validity info may be associated with any of time and location attributes. For example, a time validity may indicate the time duration (e.g. in terms of symbols, slots) during which any of the first/second RS configs may be assumed to be valid. After the end/expiry of the time duration, the UE may assume the RS beams associated with the first/second RS configs are no longer available/valid. In another example, a location validity may indicate the coverage area or location, possibly that associated with UE location and/or cell ID, in which any of the first/second RS configs may be assumed to be valid. Outside of the location validity, the UE may assume the RS beams associated with the first/second RS configs are no longer available/valid, for example.

With respect to NES states and/or modes, the WTRU may be configured with association info between NES states/modes and the corresponding RS configurations. For example, when configured with cell DTX config, which may include certain periodically occurring active and non-active periods, the sync signals associated with the first RS config may be available during the cell DTX non-active periods or when cell DTX is deactivated, and the NES-RS associated with the second RS config may be available during the cell DTX active periods. Alternatively, the sync signals may be available in a group of symbols/slots/periods and the NES-RS may be available in another group of symbols/slots/periods, for example.

According to some embodiments, a WTRU may receive one or more indications from NW (e.g. serving cell) associated with any one or more of the RS configurations (e.g. first and second RS configs) of NES cells. Such indication(s) may be received in any of the following: L3/RRC signaling (e.g. such indication may be received in any dedicated RRC messages for UE in connected/inactive mode in broadcast messages (e.g. MIB, SIBx) for UE in idle/inactive mode), L2 signaling (e.g. such Indication may be received in MAC CE or any access stratum (AS) layer signaling such as PDCP or RLC control PDU), and/or L1 signaling (e.g. such indication may be received in DCI, including in any of scheduling/non-scheduling DCI formats, TCI state indication (e.g. activation/deactivation of TCI states), measurement related DCI (e.g. aperiodic CSI), paging DCI, wake-up signaling).

In some embodiments, the indication received by a WTRU associated with the RS configurations may indicate and/or contain any one or more of, or any combination of, the following: enabling/disabling or activation/deactivation of RS configs, indication of measurement configuration (for example as shown in the example of FIG. 2A at 201—indication on 1^{st} measurement config), parameters associated with RS beams in RS configs, indication on start/end transmission of RS beams, and/or signalling indicating the enabling/disabling or activation/deactivation of NES adaptations/states.

With respect to the indication of enabling/disabling or activation/deactivation of RS configs, such indication (e.g. indicating ids/indexes) on RS configs may be associated with any of the one of more RS configs associated with the first and second RS configs. For example, the first RS config (e.g. for sync signals) may be associated with multiple RS configs, where each of the RS config may be configured with different sets of parameters (e.g. periodicity, number of beams in burst, etc). The activation/deactivation indication correspond to the first RS config may activate/deactivate at least one of the configured RS configs, for example. Such indication on RS configs may be associated with any of periodic, semi-persistent, aperiodic or on-demand RS beams. For example, periodic RS configs may be triggered with RRC signalling. A subset of parameters (e.g. comb pattern, TCI states) associated with the RS configs may be indicated/updated with dynamic signalling (e.g. MAC CE and/or DCI). Such indication on activation or deactivation of RS configs may be received in a bitmap format, possibly with a certain configured length corresponding to the number of configured RS configs, where the bit ‘1’ in the bitmap may indicate the activation of an RS config and bit ‘0’ may indicate deactivation of an RS config. When receiving an activation indication, the UE may assume the RS beams/resources associated with the activated RS configs are usable, e.g. for measurements. The UE may assume the resources in the activated RS configs may be used for measurements immediately, after certain application time (e.g. configured/indicated) or after receiving another triggering indication, for example. When receiving a deactivation indication, the UE may assume the resources associated with the deactivated RS configs are not usable for measurements. The UE may assume the resources in the deactivated RS configs may be unused for measurements immediately, or after certain application time (e.g. configured/indicated), for example. In example, the indication may include info on new or updated parameters associated with the RS configs. For example, the indication may indicate a set of new resources/beams (e.g. in time, frequency, spatial domain) for one or more RS configs. Alternatively or additionally, the indication may indicate a new resource/TCI pool from which the UE may select the resources/beams for one or more RS configs. When receiving new or updated parameters, the indication may include the index/id of the RS configs for which the new/updated parameters may be applicable or not applicable, for example.

With respect to the indication of measurement configuration, for example as shown in the example of FIG. 2A at 201 (e.g. indication on 1^{st} measurement config), the indication may indicate to perform measurements on any of the measurement objects (e.g. sync signals, NES-RS, SSB beams) associated with the first and/or second RS configs. Such indication may include any of the id/index of the RS configs where the measurement objects are located and ids/indexes of measurement objects (e.g. specific or subset of RS beams in an RS config). Such indication may include events and/or threshold values (e.g. RSRP threshold values) associated with measurements. For example, an event may correspond to sending an indication/report to NW if the RSRP measurements are made on a set of RS beams is above/below a threshold value.

With respect to the parameters associated with RS beams in RS configs, for example, the indication may indicate any one or more of the following: the id/index of the NES cell, ID/index of RS config, application time/delay, start offset of the first RS beam in a burst, RS beam burst duration, position of RS beams in burst (e.g. bitmap indicating the RS beams that are activate/inactive in burst), and/or periodicity.

With respect to the indication on start/end transmission of RS beams, for example, the indication may include the timing info (e.g. in terms of absolute time symbols/slots/ms or relative time with respect to reference symbols/slots/ms) for the transmission of RS beams (e.g. expected timing for UE for the reception of RS beams). For example, the timing info may be indicated per RS config. In another example, the indication may include the timing info for ending/stopping RS beam transmission. Such indication may provide the length/duration of time (e.g. max number of symbols, slots, ms) for completing RS beam transmission that may be no later than a time window. Such indication on RS beam transmission may be received in a separate indication or in the same indication as that of (de)activation of RS configs.

With respect to the signalling indicating the enabling/disabling or activation/deactivation of NES adaptations/states, for example, such indication may indicate the NES adaptation schemes (e.g. ids/indexes) such as SD/PD adaptations and cell DTX/DRX, based on which the UE may determine/identify the associated RS configs. In an example, the indication may include the timing info (e.g. in terms of absolute time symbols/slots/ms or relative time with respect to reference symbols/slots/ms) indicating when the NES adaptation is expected to start/end.

In some embodiments (as introduced above), the WTRU may receive an indication on a first measurement config, as shown at 201 in the example of FIG. 2A. According to some embodiments, the (first) measurement config may be for an RS config associated with the first RS config (e.g. config for sync signals). When in CONN mode, such indication may be received in any of L3/RRC, L2 or L1/DCI signaling. For a WTRU in IDLE mode, such indication may be received in SIBx, in a paging message (e.g. L1/DCI indication, paging early indication), initial access messages (e.g. Msg2, MsgB, Msg4) and WUS response message. Such indication may indicate a request to perform measurements on the sync signals in the first RS config, for example. Such indication may include the IDs/indexes of one or more NES cells, id/index of at least one RS config associated with first RS config and possibly one or more RSRP threshold values. Upon receiving the indication, the UE may perform measurements on the sync signals/RS beams received from the indicated NES cells. Such measurements, possibly on the wide beam sync signals, may be associated with any of L3, L2 and/or L1 measurements. When performing measurements on the RS beams received from one or more NES cells, the WTRU may apply parameters associated with different spatial Rx filters, for example. During measurements, for example, if the WTRU detects both always-on SSBs (from another non-NES cell) and sync signals (from an NES cell), the WTRU may prioritize measurements on the sync signals, possibly upon receiving the measurement config.

The WTRU may determine or identify suitability for mobility, e.g., cell switch, handover, or reselection, based on the measurements and/or sync signals received from the NES cell. In some examples, the WTRU may identify one or more preferred or selected RS beams in the first RS config based on the measurements, where the preferred or selected RS beams may be those with RSRP or other measured characteristic (e.g., RSRQ, SINR, AoA, TDoA) above a threshold value.

In some embodiments, as shown at 202 in the example of FIG. 2B, the WTRU may send a measurement report or indication, possibly to the cell from which the WTRU received the first measurement config (e.g. serving cell or camping cell). The measurement report may include any one or more of the IDs/indexes of NES cell(s) on which measurements are made, measured signal characteristics (e.g. RSRP measurements) of the sync signals/RS beams in the first RS config and IDs/indexes of one or more preferred or selected RS beams in the first RS config. When in CONN mode, the WTRU may send the report/indication in any of RRC signaling, L2 (e.g. UL MAC CE) or L1 (e.g. UCI, PUCCH, PUSCH) signaling. When in IDLE mode, the WTRU may send the report/indication, at least in part, in any of initial access messages (e.g. Msg1, MsgA, Msg3, Msg5), UL WUS resource/signal and common set of resources possibly accessed on contention basis. Such measurement reports/indication may indicate the suitability of cell switching or cell selection of the WTRU to an NES cell.

In some embodiments, for example as shown in FIG. 2B at 203, the WTRU may receive an indication on a second measurement config. For example, the (second) measurement config may be for an RS config associated with the second RS config (e.g. NES-RS config). When in CONN mode, such indication may be received in any of L3/RRC, L2 or L1/DCI signaling. For a WTRU in IDLE mode, such indication may be received in any of SIBx, paging message (e.g. L1/DCI indication), initial access messages (e.g. Msg2, MsgB, Msg4) and WUS response message. Such indication may indicate a request to perform measurements on the one or more NES-RS beams in the second RS config, for example. Such indication may include, for example, any one or more of the IDs/indexes of at least one NES cell, and/or ID/index of at least one RS config associated with second RS config and id/index(es) of one or more NES-RS beams in second RS config (e.g. subset of beams) associated with the NES cell. The indicated NES-RS beams of the NES cell may be in the general direction where the WTRU may be located. Such NES-RS beams may be transmitted by the NES cell, possibly for a limited time duration (e.g. for energy savings) for the WTRU to perform enough measurements and cell switch/cell reselection to the NES cell, for example.

According to some embodiments, the UE may determine the spatial relation and/or timing info for performing measurements on the one or more NES-RS beams in second RS config. Such spatial relation and/or timing info may be determined based on at least the second measurement config (e.g. associated with second RS config) and info on ids/index(es) of the NES-RS beams that may be indicated by the NW. For example, the WTRU may determine the spatial relation (e.g. parameters and/or weight values associated with a spatial Rx filter) to apply for receiving the indicated NES-RS beams based on the spatial filter (e.g. parameters and/or weight values associated with a spatial Rx filter) applied for the sync signals/RS beams in first RS config and the configured QCL/spatial relation info associated with the second RS config (e.g. indicating the relation/mapping between the indexes of sync signals in first RS config and indexes of NES-RS beams in second RS config). For example, when using spatial relation x for receiving a wide-beam sync signal with index i, the UE may use the same spatial relation x for receiving any of the narrow-beam NES-RS beams with indexes {a, b, c, d, e}. For the timing info, the UE may determine the timing for receiving the indicated NES RS beams based on the timing of the beams in first RS config and the configured timing relation info associated with the second RS config (e.g. indicating the timing offset between the last symbol of a sync signal in first RS config and the first symbol of a first NES-RS beam in a burst in second RS config).

In some embodiments, the WTRU may perform measurements on the indicated NES-RS beams received from the indicated NES cells. Such measurements, possibly on the one or more narrow NES-RS beams, may be associated with any of L3, L2 and/or L1 measurements. When performing measurements on the RS beams, the WTRU may apply spatial relation (e.g. spatial Rx filters) that were applied when making measurements on the sync signals that may be in QCL/spatial relation with the indicated NES-RS beams, for example.

According to some embodiments, for example as shown in FIG. 2C at 204, the WTRU may send the measurement report or indication, possibly to the cell from which the WTRU received the second measurement config (e.g. serving cell or camping cell). The measurement report may include measured signal characteristics of the NES RS beams (e.g. RSRP measurements of the NES RS beams). When in CONN mode, the WTRU may send the report/indication in any of RRC signaling, L2 (e.g. UL MAC CE), and L1 (e.g. UCI, PUCCH, PUSCH) signaling. When in IDLE mode, the WTRU may send the report/indication, at least in part, in any of initial access messages (e.g. Msg1, MsgA, Msg3, Msg5), UL WUS resource/signal and common set of resources possibly accessed on contention basis.

In some embodiments, as shown in the example of FIG. 2C at 205, the WTRU may receive, in an indication, a request or command to perform mobility, such as cell-switch/handover/cell reselection, to an NES cell (e.g. ID/index of NERS cell) and/or to an NES-RS of the NES cell. Such indication or command (e.g. PRACH order) may include one or more PRACH preambles/resources for the UE to transmit when performing cell switch to the NES cell. Alternatively or additionally, the WTRU may use the PRACH preambles/resources received from the NES cell for performing UL transmission for cell switch/cell reselection. In some examples, the WTRU may receive conditions (e.g. L3/L1-RSRP measurement threshold values and/or time duration values) associated with one or more NES cells and/or NES-RS of the NES cells for the WTRU to perform conditional cell-switch/handover to. In this case, for example, the WTRU may perform cell switch to an NES cell and/or to an NES-RS of an NES cell if any of the associated conditions for cell-switch/handover are met. Such indication (e.g. on command for cell switch/cell reselection) may be received in any of L3/RRC, L2 or L1/DCI signaling when in CONN mode. Such indication may be received in any one or more of SIBx, paging message (e.g. L1/DCI indication), initial access messages (e.g. Msg2, MsgB, Msg4) and/or WUS response message when in IDLE mode, for example.

According to some embodiments, the WTRU may perform mobility, such as cell switch, handover and/or cell reselection, to the indicated NES cell and/or to an NES-RS beam of the NES cell by transmitting an indication. For example, as shown in the example of FIG. 2C at 206, the WTRU may transmit an indication for cell switch, handover and/or reselection. The indication may be or may include any of a PRACH preamble and/or an UL indication (e.g. UL WUS signal, PUCCH/UCI/SR) using the provided resources. For example, the WTRU may select a best NES-RS beam, possibly selected based on highest RSRP, for transmitting the PRACH preamble/UL indication associated with the selected NES-RS beam.

Some example embodiments may include or may be directed to enabling link maintenance and/or recovery without always-on reference signals. In some embodiments, the WTRU determines the RS beams associated with one or more NES-RS configs, possibly from a set of pre-configured NES-RS configs, that may be used as RLM-RS beams for link monitoring/maintenance and radio link failure detection/recovery procedures when the serving cell (e.g. NES Cell) operates in NES mode (e.g. always-on SSBs are not transmitted). Using such RS beams in NES-RS configs may result in enabling a discontinuous RLM procedure and may effectively avoid radio link failure (RLF) scenarios, for example. The RS beams associated with NES-RS configs, may possibly be configured and/or used as QCL sources for other signals/channels (e.g. DMRS of PDCCH, DMRS of PDSCH, SRS) or measurement objects (e.g. for L3, L2, L1 measurements). During RLM, the UE may determine to change a set of one or more RLM-RS beams associated with an NES-RS config, with another set of NES-RS beams, possibly associated with a different NES-RS config, based on config/indications received from network, measurements and detection of events/conditions.

In some embodiments, the WTRU may be configured with RS beams and/or NES-RS configurations and/or parameters associated with RLM. For example, a WTRU may receive configuration information (e.g. from NW) associated with one or more RS beams and NES-RS configs, possibly for RLM/RLF. Such configuration info may be received, entirely or one or more parts, in any of L3/RRC signalling, L2/MAC signaling (e.g. MAC CE) or L1/PDCCH (e.g. DCI) indications. Such config info may include any of the combination of one or more of the following: RS beams/NES-RS configs for RLM (RLM-RS), parameters associated with RLM, and/or application time/delay.

With respect to the RS beams/NES-RS configs for RLM (RLM-RS), for example, the WTRU may be configured with one or more RS beams that may be grouped into a set that may be associated with one or more NES-RS configs. The RS beams in a set/NES-RS config may be associated with common property/characteristics, possibly in any of time, frequency, and spatial domains, for example. The WTRU may be configured with parameters of NES-RS configs, including any of start timing, number of NES-RS beams in a burst, number of NES-RS bursts in a window, periodicity and frequency band. In some examples, the RS beams in a set/NES-RS config may be configured as RLM-RS (e.g. as QCL source for RLM). For example, the WTRU may use subset of the RS beams in an NES-RS config as first RLM-RS and another subset of the RS beams in the same/different NES-RS config may be used as second RLM-RS, possibly when detecting any events/conditions that may trigger the change of the RLM-RS. In some examples, the RS beams possibly used as target RLM-RS that may replace the RS beams used as first RLM-RS may as associated with any of common/similar QCL properties, common spatial relation and common TCI pool.

With respect to the parameters associated with RLM, for example, the WTRU may be configured with any one or more of the following set of parameters: RLM-RS monitoring periodicity (e.g. periodicity at which the UE may perform measurements of RLM-RS), max/min count associated with radio link failure (N1), max/min count associated with radio link recovery (N2), max/min time duration associated with RLM (T1), and/or max/min time duration associated with radio link recovery (T2). In some examples, N1 may be referred to as NQout and N2 may be referred to as NQin. Such N1 and N2 values may be related to the max counts for meeting BLER targets for hypothetical reception of signals/channels from NW (e.g. PDCCH) when using the RLM-RS as the QCL source. The T2 value may be associated with the T310 timer, for example. Such parameters for RLM may be used for detecting any conditions/events associated with link failure and link recovery. For example, when the detected number of link failure counts exceed N1, a radio link failure event may be declared. The set of parameters for RLM may be associated with the RS beams used as RLM-RS. The set of RLM parameters may be the same or different for the different sets of RS beams used as first RLM-RS and second RLM-RS (e.g. first RLM-RS beam and second RLM-RS beam may use different set of values for {N1, N2, T1, T2}). In some examples, when configured for beam failure monitoring/recovery, the UE may be configured with set of parameters including max/min count associated with beam failure detection (M1), max/min count associated with beam failure recovery (M2) and max/min time duration associated with beam recovery (T3). Such parameters for beam failure may be the same or different than those used for RLM, for example.

With respect to the application time and/or delay, the WTRU may be configured with one or more application time/delay values, which may indicate a time duration starting with a time instance (e.g. symbol/slot) from the reception of an indication indicating the availability of NES-RS/RLM-RS beams in an NES-RS config to the time instance when the NES-RS/RLM-RS beams are actually available, e.g. for reception/measurements. Alternatively or additionally, the application time/delay may indicate a time duration starting with a time instance from the reception of an indication indicating the unavailability of NES-RS/RLM-RS beams in an NES-RS config to the time instance when the NES-RS/RLM-RS beams are actually unavailable, e.g. for measurements.

In some embodiments, a WTRU may perform radio link failure (RLF) detection procedure(s) with NES-RS beams. For example, according to some embodiments, the UE may receive an indication (e.g. from NW) associated with activation of one or more NES-RS configs, possibly for RLM. Such indication may be received in any of L3/RRC signaling, L2/MAC signaling (e.g. MAC CE) and L1/PDCCH (e.g. DCI) indications, for example. Such indication may indicate any of the signaling/info/parameters described in detail above. For example, the indication may indicate activation of a set of NES-RS beams, possibly associated with an NES-RS config, that may be used for RLM measurements. Such indication may be received as part of another one or more indications on NES mode or NES adaptation, for example.

According to some embodiments, the WTRU may determine a first set of one or more NES-RS beams as first RLM-RS beams, possibly from an NES-RS config (e.g. first NES-RS config) that is activated (e.g. active NES-RS config). The WTRU may determine the first RLM-RS beams based on the configured parameters associated with the first NES-RS config and RLM parameters. In an example, the WTRU may determine the first RLM-RS beams from an activated NES-RS config that has a start time (e.g. first symbol of a first RS beam in a burst/window) that is no later than a threshold value and/or an end time (e.g. last symbol of a last RS beam in a burst/window) that is within the time duration associated with the T1 and/or N1 parameters. In an example, when multiple first RLM-RS beams are available for RLM measurements, the WTRU may hop between the multiple beams, possibly based on a hopping/comb pattern (e.g. in time and/or frequency domain) when performing such measurements.

In some embodiments, the WTRU may perform RLM measurements (e.g. any of L3, L2, L1 measurements of EPRE, RSRP, RSSI, RSRQ) on the one or more first RLM-RS beams. In the case when some pre-existing RLM-RS beams, possibly associated with an always-on SSB config or another NES-RS config, are still available and/or used when the WTRU determines the first RLM-RS beams, the WTRU may perform any one or more of the following: continue performing measurements on the pre-existing RLM-RS beams possibly along with measurements of the first RLM-RS beams (e.g. in the symbols/slots/occasions when the first RLM-RS beams are received) and/or stop/suspend performing measurements on pre-existing RLM-RS beams. The WTRU may send an indication to the NW indicating any of the stopping of RLM measurements on the pre-existing RLM-RS, report on the measurements made on the pre-existing RLM-RS (up to stopping time instance) and/or confirmation indication on switching to the first RLM-RS (e.g. ids/indexes of first RLM-RS beams or id/index of the NES-RS config associated with the first NES-RS beams).

According to some embodiments, when any link failure conditions (e.g. RSRP is less than a threshold value) are detected during RLM measurements on the first RLM-RS beams, the WTRU may increment a link failure counter at each RLM measurement instance. For example, when making RLM measurements on the pre-existing RLM-RS and when the link failure counter is incremented to a certain n1 value, the WTRU may continue the count x in the counter when using the first RLM-RS and continuing with the RLM measurements (e.g. counter=n1+x). Alternatively or additionally, when using the first RLM-RS, the WTRU may reset the link failure counter (e.g. counter=0) and apply new count value when making RLM measurements. Such resetting of the link failure counter when using NES-RS beams (from a first NES-RS config) may be conditional on any of the following: QCL/TCI pool in which the pre-existing and first RLM-RSs belong to, the time duration for switching between pre-existing and first RLM-RS, mobility of the WTRU, value of n1 prior to using NES-RS beams from first NES-RS config, etc. For example, when the pre-existing RLM-RS and the first RLM-RS beams belong to different TCI pools or have different QCL properties, the WTRU may reset the link failure counter. Otherwise, if both pre-existing and first RLM-RSs have the same QCL properties, the WTRU may continue the count value in the counter when using the NES-RS beams from the first NES-RS config.

In an example, when detecting a link failure event (e.g. number of consecutive link failure counts are greater than or equal to N1), the WTRU may determine a second set of one or more RLM-RS beams, possibly from another NES-RS config (e.g. second NES-RS config) that is activated for replacing the first RLM-RS beams. Alternatively or additionally, the WTRU may determine a second RLM-RS beams in a second NES-RS config when the first RLM-RS beams in the first NES-RS config are no longer available (e.g. UE may receive indications on transmission of last set of NES-RS beams in first NES-RS config or deactivation of first NES-RS config). For example, the WTRU may determine a second RLM-RS beams from an active NES-RS config that has a start time (e.g. first symbol of a first NES-RS beam in a burst/window) that is no later than a threshold value and/or an end time (e.g. last symbol of a last RS beam in a burst/window) that is within the time duration associated with T2 and/or N2 parameters. The WTRU may also determine the second RLM-RS beams from an NES-RS config that has a first set of NES-RS beams that may be available (e.g. for measurements) no later than a threshold time duration/gap after the time instance when N1 counts are detected. In an example, when multiple second RLM-RS beams are available for RLM measurements, the WTRU may hop between the multiple beams, possibly based on a hopping/comb pattern (e.g. in time and/or frequency domain) when performing such measurements.

In some embodiments, the WTRU may send an indication to NW, possibly indicating detection of link failure event (e.g. when using the first RLM-RS in first NES-RS config), measurements made on the first RLM-RS beams and selection of the second RLM-RS beams in a second NES-RS config (e.g. id/indexes of beams/config). Alternatively, if there are no active NES-RS configs that meet the selection criteria associated with the RLM parameters (e.g. T2, N2) and time duration thresholds, the UE may send an indication to request for new set of RS beams or new NES-RS config that may be used as second RLM-RS beams.

According to some embodiments, the WTRU may perform radio link recovery procedure(s) with NES-RS beams. In an example, the selected/determined second RLM-RS beams may be used for link failure recovery procedure. In this case, the WTRU may perform measurements (e.g. any of L3, L2, L1 measurements) on the one or more NES-RS beams determined as the second RLM-RS. When any link recovery conditions (e.g. RSRP is greater than a threshold value) are detected during RLM measurements on the second RLM-RS beams, the WTRU may increment a link recovery counter at each RLM measurement instance. The WTRU may start a timer associated with T2 when triggering the link recovery procedure (e.g. when detecting the first link recovery count or when using the second RLM-RS beams). In another example, the WTRU may have triggered link recovery procedure (e.g. incrementing the link recovery counter to n2 and/or started the T2 timer) during measurements on the first RLM-RS beams. In this case, when using the second RLM-RS beams, the WTRU may continue the count y in the link recovery counter when making measurements on the second RLM-RS (e.g. counter=n2+y). Alternatively or additionally, when using the second RLM-RS, the WTRU may reset the link recovery counter (e.g. counter=0) and/or the T2 timer. In this case, the WTRU may apply new count value and/or restart the T2 timer when making RLM measurements using second RLM-RS for link recovery. Such resetting of the link recovery counter may be conditional on any of the same/similar conditions associated with link failure (described above).

In some embodiments, when detecting a link recovery event (e.g. number of consecutive link recovery counts are greater than or equal to N2 and/or the T2 timer has not expired), the WTRU may reset the T2 timer/N2 counter and/or may send an RLM report to the network, indicating any of the measurements (e.g. L3, L1 RSRP measurements) made on the first and/or second RLM-RS beams, IDs/indexes of the first and/or second NES-RS configs, count values for link failure and recovery, etc. In the case when link recovery is not possible (e.g. T2 timer expires and/or number of consecutive link recovery counts are less than N2), the WTRU may send an indication to request for new set of NES-RS beams, new NES-RS configs or send a PRACH preamble (e.g. using CBRA/CFRA PRACH resources for triggering RRC connection re-establishment). The examples described for link failure detection and link recovery using first and second RLM-RS beams may also be applied for beam failure detection and beam recovery procedures, possibly using the set of configured parameters (e.g. M1, M2, T3) associated with beam management.

In some embodiments, the WTRU may receive an indication on any of activation of an NES-RS config and the start of an NES-RS config (e.g. start of a first NES-RS beam in an NES-RS config). Such indication may indicate the start timing/offset (e.g. start symbol/slots/half-frame) on when the first NES-RS beam in a burst associated with the NES-RS config may be expected/received by the WTRU, for example. Such indication may be received in any of L3/RRC, L2/MAC (e.g. DL MAC CE) or L1 (e.g. group-common DCI or UE specific DCI). The WTRU may also be configured with one or more conditions/events associated with monitoring of NES-RS beams. Such events/conditions may be associated with any of measurement configs (e.g. L3, L2, L1 measurements) for RLM, RRM/mobility, BM, etc. In this case, the WTRU may monitor for an NES-RS beam, possibly in a BWP, resources or search space associated with the NES-RS config, when triggered by an event/condition associated with the measurement config. For example, a measurement config may indicate periodic RLM measurements of RLM-RS beams with a certain periodicity value. When the NES-RS beams of an NES-RS config are configured as RLM-RS beams, the WTRU may locate the NES-RS beams when the condition for monitoring/measurements is met (e.g. at each periodic measurement time instance). In an example, when a condition for monitoring/measurements of an NES-RS beam is met, the WTRU may determine the next available NES-RS beam, possibly in a burst, based on the config info of the NES-RS config and the info on the start timing/offset received in the indication. In the case when the next available NES-RS beams in a burst is above/below a threshold value, the WTRU may send an indication to NW (e.g. in any of L3, L2, L1 signaling, initial access messages, PRACH preamble and UL WUS), possibly to request for another NES-RS beam/burst/config.

As discussed in detail above, a WTRU may perform a mobility event, such as cell switch, handover and/or reselection, to an NES cell (i.e. cell that is not transmitting always-on SSBs) based on the configuration information/indications received from a serving cell on the beams of a first RS configuration (e.g. wide beams consisting of only sync signal) and/or a second RS configuration (e.g. narrow beams consisting of dynamically triggered SSBs) associated with the NES cell.

According to some embodiments, a WTRU, such as any of WTRUs 102a-102d illustrated in FIGS. 1A-1D, may include circuitry such as a processor, memory, transmitter and/or receiver. The circuitry may be configured to receive configuration information, which may include any of first RS configuration(s) and second RS configuration(s).

The first RS configuration (e.g. associated with wide beams including only PSS/SSS) associated with NES cell(s). The first RS configuration may include or indicate any one or more of the following parameters: periodicity (e.g. periodicity associated with a first RS or associated with the first RS configuration(s)), ID/index(es) associated with a first RS or first RS configuration(s), and/or the number of beams in a burst associated with the first RS or first RS configuration(s). In some embodiments, the first RS configuration may additionally or alternatively include any of the other parameters that are discussed in detail above (e.g. in reference to FIG. 2).

The second RS configuration (e.g. associated with narrow beams including dynamically triggered SSBs) associated with NES cell(s). The second RS configuration may include or indicate any one or more of the following parameters: an association between the beams associated with or in the first RS configuration and the beams associated with or in the second RS configuration, periodicity (e.g. periodicity associated with a second RS or associated with the second RS configuration(s)), ID/index(es) associated with a second RS or second RS configuration(s), and/or the number of beams in a burst associated with the second RS or second RS configuration(s). For example, the indication of the association between the beams in first RS configuration and second RS configuration may include any one or more of: an indication of an association between a beam (e.g., one wide beam) in the first RS config with one or more, or two or more, beams (e.g. N narrow beams) in the second RS config; an indication of QCL and/or spatial relation information between beams in the first RS and second RS configurations (e.g. mapping between an index of a beam in first RS config and indexes of N beams in second RS config); and/or timing relation information between beams in the first RS and second RS configurations (e.g. timing offset between the end symbol of a beam in first RS config and the start symbol of N beams in second RS config).

In some embodiments, the circuitry may be configured to receive an indication (e.g. from serving cell) on a first measurement configuration. The indication may include an ID/index of (or associated with) the first RS configuration (e.g. an ID associated with one or more first RS). In some embodiments, the indication may include an indication of events (e.g. RSRP threshold values) associated with the NES cell. In some embodiments, the circuitry may be configured to perform measurements (e.g. measurements of signal characteristics or RSRP measurements) on the beams (in the first RS config) that are received from NES cell. For example, the circuitry may be configured to identify one or more preferred or selected beams in first RS configuration based on the measurements (e.g. based on the measurements being above a configured threshold or RSRP threshold). As an example, the measurements may be associated with any of L3(RRC), L2 and/or L1 measurements.

According to some embodiments, the circuitry may be configured to send information, such as a measurement report (e.g. to serving cell). The measurement information or report may include any one or more of: RSRP measurements (or other type of measurements, e.g., RSRQ, SINR, AoA, TDoA) made on the beams associated with first RS configuration, and/or an ID, index and/or information of (or associated with) at least one preferred or selected beam in first RS configuration.

In some embodiments, the circuitry may be configured to receive an indication (e.g. from serving cell) on a second measurement configuration. For example, the indication may include any one or more of: ID/index of second RS config, and/or index(es) of beams in second RS configuration (e.g. subset of beams) associated with the NES cell (e.g. the same NES cell as the first measurement configuration or a different NES cell from the one associated with the first measurement configuration). For instance, the indication may be received in any of L3 (RRC signaling), L2 (MAC CE) or L1(DCI).

According to some embodiments, the circuitry may be configured to determine the spatial relation and/or timing information for measuring the beams in the second RS configuration, based on the second measurement configuration (or the second RS config) info and/or the indication on index(es) of beams. For example, the circuitry may be configured to determine the spatial (Rx) filter to apply for receiving the indicated beams based on the spatial (Rx) filter applied for the beams in first RS configuration and/or the QCL or spatial relation information. For example, the circuitry may be configured to determine the timing for receiving the indicated beams based on the timing of the beams in first RS configuration and the timing relation information.

In some embodiments, the circuitry may be configured to perform measurements on the beams in second RS configuration that are received from the NES cell. For example, the circuitry may be configured to send a measurement report (e.g. to serving cell) indicating the measurements made (e.g. RSRP measurements) on the beams received from NES cell in the second RS configuration.

According to some embodiments, the circuitry may be configured to perform or determine to perform a mobility event, such as cell switch, handover and/or reselection (e.g. by transmitting PRACH preamble as discussed above) to a beam in, indicated by, or associated with the second RS configuration. For example, in one embodiment, the circuitry may be configured to transmit a PRACH preamble to a selected beam (e.g. beam with highest RSRP) associated with the NES cell, e.g., upon or after receiving a cell switch or handover command from serving cell.

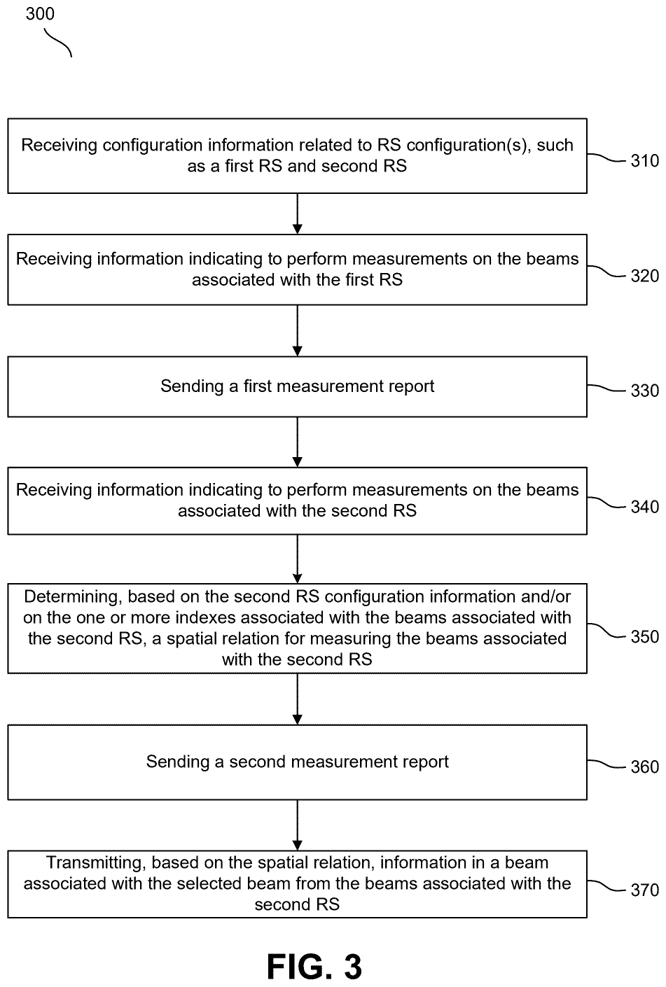

FIG. 3 illustrates an example flow diagram of a method 300 for or relating to data routing (e.g., as introduced and discussed above), for example in multi-connectivity with NES, according to some example embodiments. The example method 300 of FIG. 3 and accompanying disclosures herein may include, may be based on, or may be a synthesization of various embodiments or elements discussed in detail above, such as those discussed with respect to FIG. 2. For convenience and simplicity of exposition, the example of FIG. 3 may be described with reference to the architecture or system described above with respect to FIGS. 1A-1D, for instance. However, the example method 300 depicted in FIG. 3 may be carried out using different architectures as well. According to some embodiments, the method 300 of FIG. 3 may be implemented by a UE or WTRU, such as the WTRU 102 described in the foregoing.

It is noted that the method 300 of FIG. 3 may include further steps, procedures or details as discussed in detail elsewhere in this disclosure. As such, the method 300 of FIG. 3 may be modified to include any of the steps, procedures, elements and/or details illustrated and/or discussed in the foregoing. Moreover, it is noted that the method and/or blocks of FIG. 3 may be modified to include, or to be replaced by, any one or more of the procedures, elements or blocks discussed elsewhere herein. As such, one of ordinary skill in the art would understand that FIG. 3 is provided as one example and modifications thereto are possible while remaining within the scope of certain example embodiments.

As illustrated in the example of FIG. 3, the method 300 may include, at 310, receiving configuration information, for example, from a network node or cell serving the WTRU. The configuration information may relate to or include one or multiple RS configuration(s) (e.g., RS configurations for or associated with a RS type). For example, the configuration information may include or may indicate first RS configuration information associated with a network energy savings cell and/or second RS configuration information associated with the network energy savings cell. In some embodiments, the first RS configuration information may indicate any of a periodicity associated with a first RS or first RS type, one or more indexes associated with the first RS or first RS type, and/or the number of beams in a burst associated with the first RS or first RS type. In some embodiments, the second RS configuration information may indicate an association between beams associated with the first RS or first RS type and beams associated with the second RS or second RS type, and may indicate any of a periodicity associated with the second RS or second RS type, one or more indexes associated with the second RS or second RS type, and/or a number of beams in a burst associated with the second RS or second RS type.

For example, in some embodiments, the first RS (e.g., the RS(s) or RS type(s) in or associated with the first RS configuration) may include one or more synchronization signals, and wherein the second RS (e.g., the RS(s) or RS type(s) in or associated with the second RS configuration) comprises any of one or more network energy savings references signals and system information.

According to some embodiments, the association between the beams associated with the first RS (e.g. first RS type) and the beams associated with the second RS (e.g. second RS type) may include any of: (1) an association between one beam associated with the first RS (e.g. first RS type) and one or more beams associated with the second RS (e.g. second RS type), (2) spatial relationship information indicating a spatial relationship between one or more beams associated with the first RS (e.g. first RS type) and one or more beams in associated with the second RS (e.g. second RS type), and/or (3) timing relationship information indicating a timing relationship between one or more beams associated with the first RS (e.g. first RS type) and one or more beams in associated with the second RS (e.g. second RS type).

In the example of FIG. 3, the method may include, at 320, receiving a message or information indicating to perform measurements on the beams associated with the first RS (e.g. first RS type) that are received from the network energy savings cell. This message or information may include, for example, any of the one or more indexes associated with the first RS (e.g. first RS type), an identifier associated with the network energy savings cell. It is noted that this message or information may additionally or alternatively indicate any of the other parameters or information discussed above (e.g., such as those discussed in connection with FIG. 2). It should be further noted that, in some embodiments, the receiving of the message at 320 may be skipped or may not occur (e.g. the WTRU may determine to perform measurements and/or to send a measurement report without receipt of the indication) and the process may proceed to block 330 discussed below. In some embodiments, the message or information received at 320 may further include an indication of one or more events associated with the network energy savings cell, as discussed elsewhere herein.

As illustrated in the example of FIG. 3, the method 300 may include, at 330, sending a measurement report indicating any of measured signal characteristics (e.g. RSRP, RSRQ, AoA, TDoA, or the like) of the beams associated with the first RS (e.g. the RS(s) or RS type(s) in or indicated by the first RS config) and/or information associated with a selected (or preferred) beam from the beams associated with the first RS (e.g. first RS type) or associated with the first RS configuration. For example, the information associated with the selected beam may include any one or more of: an identifier of the selected beam, measurements associated with the selected beam, spatial and/or timing information associated with the selected beam, and/or a delta/difference between the selected beam and the next best or preferred beam.

In the example of FIG. 3, the method may include, at 340, receiving a message or information indicating to perform measurements on the beams associated with the second RS (e.g. second RS type) that are received from the network energy savings cell. For instance, this message or information may include any of the one or more indexes associated with the second RS (e.g. second RS type), one or more indexes associated with beams associated with the second RS (e.g. second RS type), and/or an identifier associated with the network energy savings cell. It should be further noted that, in some embodiments, the receiving of the message at 340 may be skipped or may not occur (e.g. the WTRU may determine to perform measurements without receipt of the indication) and the process may proceed to block 350 discussed below.

In some example embodiments, the method could include performing measurements on the beams associated with the first RS (and/or the second RS) that are received from NES cell, and selecting one or more beams associated with the first RS (and/or the second RS) based on the measurements. The measurements may include reference signal received power (RSRP) measurements (or RSRQ, AoA and/or TDOA, etc. measurements), and the selecting may include selecting the one or more beams based on the RSRP measurements (or RSRQ, AoA and/or TDOA, etc. measurements) of the one or more beams being above a threshold (e.g. a configured or RSRP threshold).

As illustrated in the example of FIG. 3, the method 300 may include, at 350, determining, based on the second RS configuration information and/or on the one or more indexes associated with the beams associated with the second RS (e.g. second RS type), a spatial relation for measuring the beams associated with the second RS (e.g. second RS type) or the second RS configuration information (e.g. the RS(s) or RS type(s) associated with or indicated by the second RS config).

According to some embodiments, the determining of the spatial relation at 350 may include determining a set of parameters associated with a spatial filter to apply for receiving the beams associated with the second RS (e.g. second RS type) based on a set of parameters associated with a spatial filter applied for the beams associated with the first RS (e.g. first RS type) and the association information (e.g. the spatial relationship information).

In some embodiments, the method may include determining, based on the second RS configuration information and/or on the one or more indexes associated with the beams associated with the second RS (e.g. second RS type), timing information for measuring the beams associated with the second RS (e.g. second RS type). In this case, the transmitted information may be transmitted based on the spatial relation and/or the timing information (e.g., this information may be transmitted using the spatial relation and/or timing information). According to some embodiments, the determining of the timing information may include determining a timing for receiving the beams associated with the second RS (e.g. second RS type) based on a timing of the beams associated with the first RS (e.g. first RS type) and/or based on the timing relationship information discussed above (e.g., the timing relationship information indicated by the association received in the configuration information).

In the example of FIG. 3, the method may include, at 360, sending a measurement report indicating any of measured signal characteristics (e.g. RSRP) of the beams associated with the second RS (e.g. second RS type) or the second RS configuration information and/or information associated with a selected beam (e.g. a beam preferred by the WTRU) from the beams associated with the second RS (e.g. second RS type).

As illustrated in the example of FIG. 3, the method 300 may include, at 370, transmitting, based on the spatial relation (e.g. using the spatial relation), information in a beam associated with the selected beam from the beams associated with the second RS (e.g. second RS type). For example, this transmitted information may include a PRACH preamble as discussed above or elsewhere herein. In some embodiments, the PRACH preamble may be transmitted to the NES cell (e.g., on a beam associated with the NES cell).

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In some example embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Any characteristic, variant or embodiment described for a method is compatible with an apparatus device comprising means for processing the disclosed method, such as with a device comprising a processor configured to process the disclosed method, a computer program product comprising program code instructions and a non-transitory computer-readable storage medium storing program instructions.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S. C. § 112, ¶6 or means-plus-function claim format, and any claim without the terms “means for”is not so intended.

Although various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although some example embodiments are illustrated and described herein, the invention is not intended to just be limited to the details shown. Rather, various modifications and variations may be made in the details within the scope and range of equivalents of the claims and without departing from the spirit or scope invention.

1. A wireless transmit/receive unit (WTRU), comprising:
circuitry, including any of a processor, memory, transmitter and receiver, the circuitry configured to
receive configuration information including (1) first reference signal configuration information associated with a network energy savings cell and (2) second reference signal configuration information associated with the network energy savings cell,
wherein the first reference signal configuration information indicates any of a periodicity associated with a first reference signal, one or more indexes associated with the first reference signal, and number of beams in a burst associated with the first reference signal, and
wherein the second reference signal configuration information indicates an association between beams associated with the first reference signal and beams associated with a second reference signal and any of a periodicity associated with the second reference signal, one or more indexes associated with the second reference signal, and number of beams in a burst associated with the second reference signal;
receive first information indicating to perform measurements on the beams associated with the first reference signal that are received from the network energy savings cell, wherein the first information includes any of the one or more indexes associated with the first reference signal and an identifier associated with the network energy savings cell;
send a measurement report indicating any of measured signal characteristics of the beams associated with the first reference signal and information associated with a selected beam from the beams associated with the first reference signal;
receive second information indicating to perform measurements on the beams associated with the second reference signal that are received from the network energy savings cell, wherein the second information includes any of the one or more indexes associated with the second reference signal, one or more indexes associated with beams associated with the second reference signal, and an identifier associated with the network energy savings cell;
determine, based on the second reference signal configuration information and on the one or more indexes associated with the beams associated with the second reference signal, a spatial relation for measuring the beams associated with the second reference signal;
send a measurement report indicating any of measured signal characteristics of the beams associated with the second reference signal and information associated with a selected beam from the beams associated with the second reference signal; and
transmit, based on the spatial relation, third information in a beam associated with the selected beam from the beams associated with the second reference signal.

2. The WTRU of claim 1, wherein the first reference signal comprises one or more synchronization signals, and wherein the second reference signal comprises any of one or more network energy savings reference signals and system information.

3. The WTRU of claim 1, wherein the configuration information is received from a network node serving the WTRU.

4. The WTRU of claim 1, wherein the association between the beams associated with the first reference signal and the beams associated with the second reference signal comprises any of: (1) an association between one beam associated with the first reference signal and one or more beams associated with the second reference signal, (2) spatial relationship information indicating a spatial relationship between one or more beams associated with the first reference signal and one or more beams associated with the second reference signal, and (3) timing relationship information indicating a timing relationship between one or more beams associated with the first reference signal and one or more beams in associated with the second reference signal.

5. The WTRU of claim 1, wherein the circuitry is configured to:
perform measurements on the beams associated with the first reference signal that are received from the network energy savings cell; and
select one or more beams associated with the first reference signal based on the measurements.

6. The WTRU of claim 5, wherein the measurements comprise reference signal received power (RSRP) measurements, and wherein the one or more beams are selected based on the RSRP measurements of the one or more beams being above a threshold.

7. The WTRU of claim 4, wherein the determination of the spatial relation comprises a determination of a set of parameters associated with a spatial filter to apply for receiving the beams associated with the second reference signal based on a set of parameters associated with the spatial filter applied for the beams associated with the first reference signal and the spatial relationship information.

8. The WTRU of claim 4, wherein the circuitry is configured to:
determine, based on the second reference signal configuration information and on the one or more indexes associated with the beams associated with the second reference signal, timing information for measuring the beams associated with the second reference signal, and
wherein the third information is transmitted based on the spatial relation and the timing information.

9. The WTRU of claim 8, wherein the determination of the timing information comprises a determination of a timing for receiving the beams associated with the second reference signal based on any of a timing of the beams associated with the first reference signal and the timing relationship information.

10. The WTRU of claim 1, wherein the first information further comprises an indication of one or more events associated with the network energy savings cell.

11. The WTRU of claim 1, wherein the third information comprises a physical random access channel (PRACH) preamble.

12. The WTRU of claim 11, wherein the physical random access channel (PRACH) preamble is sent to the network energy savings cell.

13. A method, implemented by a wireless transmit/receive unit (WTRU), the method comprising:
receiving configuration information including (1) first reference signal configuration information associated with a network energy savings cell and (2) second reference signal configuration information associated with the network energy savings cell,
wherein the first reference signal configuration information indicates any of a periodicity associated with a first reference signal, one or more indexes associated with the first reference signal, and number of beams in a burst associated with the first reference signal,
wherein the second reference signal configuration information indicates an association between beams associated with the first reference signal and beams associated with a second reference signal and any of a periodicity associated with the second reference signal, one or more indexes associated with the second reference signal, and number of beams in a burst associated with the second reference signal;
receiving first information indicating to perform measurements on the beams associated with the first reference signal that are received from the network energy savings cell, wherein the first information includes any of the one or more indexes associated with the first reference signal and an identifier associated with the network energy savings cell;
sending a measurement report indicating any of measured signal characteristics of the beams associated with the first reference signal and information associated with a selected beam from the beams associated with the first reference signal;
receiving second information indicating to perform measurements on the beams associated with the second reference signal that are received from the network energy savings cell, wherein the second information includes any of the one or more indexes associated with the second reference signal, one or more indexes associated with beams associated with the second reference signal, and an identifier associated with the network energy savings cell;
determining, based on the second reference signal configuration information and on the one or more indexes associated with the beams associated with the second reference signal, a spatial relation for measuring the beams associated with the second reference signal;
sending a measurement report indicating any of measured signal characteristics of the beams associated with the second reference signal and information associated with a selected beam from the beams associated with the second reference signal; and
transmitting, based on the spatial relation, third information in a beam associated with the selected beam from the beams associated with the second reference signal.

14. The method of claim 13, wherein the first reference signal comprises one or more synchronization signals, and wherein the second reference signal comprises any of one or more network energy savings reference signals and system information.

15. The method of claim 13, wherein the configuration information is received from a network node serving the WTRU.

16. The method of claim 13, wherein the association between the beams associated with the first reference signal and the beams associated with the second reference signal comprises any of: (1) an association between one beam associated with the first reference signal and one or more beams associated with the second reference signal, (2) spatial relationship information indicating a spatial relationship between one or more beams associated with the first reference signal and one or more beams in associated with the second reference signal, and (3) timing relationship information indicating a timing relationship between one or more beams associated with the first reference signal and one or more beams in associated with the second reference signal.

17. The method of claim 13, comprising:
performing measurements on the beams associated with the first reference signal that are received from the network energy savings cell; and
selecting one or more beams associated with the first reference signal based on the measurements.

18. The method of claim 17, wherein the measurements comprise reference signal received power (RSRP) measurements, and wherein the selecting comprises selecting the one or more beams based on the RSRP measurements of the one or more beams being above a threshold.

19. The method of claim 16, wherein the determining of the spatial relation comprises determining a set of parameters associated with a spatial filter to apply for receiving the beams associated with the second reference signal based on a set of parameters associated with a spatial filter applied for the beams associated with the first reference signal and the spatial relationship information.

20. The method of claim 16, comprising:
determining, based on the second reference signal configuration information and on the one or more indexes associated with the beams associated with the second reference signal, timing information for measuring the beams associated with the second reference signal, and
wherein the transmitting of the third information is based on the spatial relation and the timing information.

21. The method of claim 20, wherein the determining of the timing information comprises determining a timing for receiving the beams associated with the second reference signal based on any of a timing of the beams associated with the first reference signal and the timing relationship information.

22. The method of claim 13, wherein the first information further comprises an indication of one or more events associated with the network energy savings cell.

23. The method of claim 13, wherein the transmitting of the third information comprises transmitting a physical random access channel (PRACH) preamble to the network energy savings cell.
